(19) United States
(12) Patent Application Publication
(10) Pub. No.: US 2025/0247890 A1
(43) Pub. Date: Jul. 31, 2025

(54) Managing Small Data Transmission With a Network

(71) Applicant: GOOGLE LLC, Mountain View, CA (US)

(72) Inventor: Chih-Hsiang Wu, Taoyuan City (TW)

(21) Appl. No.: 18/853,253

(22) PCT Filed: Apr. 6, 2023
(86) PCT No.: PCT/US23/17714

§ 371 Date: Oct. 1, 2024

Related U.S. Application Data
(60) Provisional application No. 63/329,333, filed on Apr. 8, 2022.

(51) Int. Cl. H04W 74/0833

(52) U.S. Cl. CPC H04W 74/0833

(57) ABSTRACT

A radio access network (RAN) and a user equipment (UE) can implement a method for managing small data transmission (SDT). The method includes: (i) operating in a state of a protocol for controlling radio resources in which the UE is not connected to the RAN; (ii) receiving an SDT configuration from the RAN; and (iii) performing, based on whether the UE and the RAN node support an SDT type that relies on a random access procedure, a communication procedure with the RAN node to transmit or receive small data.

### CROSS-REFERENCE TO RELATED APPLICATIONS

This application claims priority to and the benefit of the filing date of provisional U.S. Patent Application No. 63/329,333 entitled “MANAGING SMALL DATA TRANSMISSION WITH A NETWORK,” filed on Apr. 8, 2022. The entire contents of the provisional application are hereby expressly incorporated herein by reference.

### FIELD OF THE DISCLOSURE

This disclosure relates generally to wireless communications and, more particularly, to communication of uplink and/or downlink data at a user equipment (UE) and a radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which provides logical channels to the Radio Link Control (RLC) sublayer. The RLC sublayer similarly provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_INACTIVE state has only one, relatively small packet to transmit. A Small Data Transmission (SDT) procedure can support data transmission for the UE operating in the RRC_INACTIVE state without transitioning to RRC_CONNECTED state.

Devices enable SDT for particular radio bearers. A UE can initiate SDT only when less than a configured amount of uplink data awaits transmission across all radio bearers for which SDT is enabled, the downlink reference signal received power (RSRP) is above a configured threshold, and a valid SDT resource is available. Further, the UE can initiate the SDT procedure with either a transmission over a random access channel (RACH), as part of a random access SDT (RA-SDT) session, or over Type 1 configured grant (CG) resources, as part of a CG-SDT session. For RA-SDT, the network configures 2-step and/or 4-step random access resources for an SDT transmission. In an RA-SDT session, the UE can perform an initial transmission including data in message 3 (MSG3) of a 4-step random access procedure, or in message A (MSGA) of a 2-step random access procedure. The network can then schedule subsequent uplink and/or downlink transmissions using dynamic uplink grants and downlink assignments, respectively, after the completion of the random access procedure.

A UE can initiate an CG-SDT session only with valid uplink (UL) timing alignment. The UE maintains the UL timing alignment using a network-configured SDT-specific timing alignment timer and a downlink (DL) RSRP of a configured number of the highest ranked synchronization signal blocks (SSBs). Upon expiration of the SDT-specific timing alignment timer, the UE releases the CG resources. After initiating CG-SDT, the UE performs an initial transmission including data, during a CG occasion using a CG, and the network can schedule subsequent uplink transmissions using dynamic grants. Alternatively, the uplink transmissions can take place during the subsequent CG resource occasions. During CG-SDT, a base station schedules downlink transmissions using dynamic assignments. The UE can initiate subsequent uplink transmission only after reception of confirmation for the initial transmission from the network.

However, in some scenarios and implementations, the UE may connect to a radio access network (RAN) node including one or more base stations. In further scenarios and implementations, the UE may receive a CG configuration configuring CG resources from a base station of the RAN. When the RAN configures the UE with the CG configuration, it is not clear whether the UE can perform a random access procedure to transmit SDT data.

### SUMMARY

A UE manages small data transmission with a network such as a RAN, including a network node. The UE operates in an inactive state and receives an SDT configuration from the RAN. The UE then performs a communication procedure with the network node based at least on whether the UE or the network node supports RA-SDT communication and/or SDT conditions are met. Depending on the implementation, the communication procedure can further depend on whether the UE or the network node supports CG-SDT and/or whether conditions for CG-SDT are met. The communication procedure can be any of a CG-SDT procedure, an RA-SDT procedure, or an RRC resume procedure.

The UE can further perform a random access procedure during a CG-SDT procedure, in response to an initiation of an RRC resume procedure, or during some other time period. The UE can then determine whether to transmit data via a configured grant or a dynamic grant based on when the random access procedure occurs. In some implementations, the UE further makes the determination based on whether the UE and/or RAN support RA-SDT.

One example embodiment of these techniques is a method for managing small data transmission (SDT) with a radio access network (RAN) including a RAN node, the method implemented in a user equipment (UE). The method includes operating in a state of a protocol for controlling radio resources in which the UE is not connected to the RAN; receiving an SDT configuration from the RAN; and performing, based on whether the UE and the RAN node support an SDT type that relies on a random access procedure, a communication procedure with the RAN node to transmit or receive small data.

Another example embodiment of these techniques is a method for managing small data transmission (SDT) with a radio access network (RAN) including a RAN node, the method implemented in a user equipment (UE). The method includes receiving an SDT configuration from the RAN node; performing a random access procedure; and transmitting, based at least on whether the UE and the RAN node support an SDT type that relies on a random access procedure, a data packet to the RAN node on one of a configured grant or a dynamic grant.

### BRIEF DESCRIPTION OF THE DRAWINGS

FIG. 1A is a block diagram of an example wireless communication system in which a user device and a base station of this disclosure can implement the techniques of this disclosure for managing small data transmission;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 illustrates an example scenario in which a UE communicates with a DU of a RAN using a non-SDT configuration before the UE receives an SDT configuration from the DU and transitions to an inactive state;

FIG. 4 illustrates an example scenario in which a UE communicates with a DU of a RAN while in an inactive state before the UE receives an SDT configuration from the DU and remains in the inactive state;

FIG. 5A illustrates an example scenario in which a UE transitions from an inactive state to a connected state before the UE receives an SDT configuration from the DU and transitions back to the inactive state;

FIG. 5B illustrates a scenario similar to that of FIG. 5A, but in which the UE does not initially communicate small data with the DU while in the initial inactive state;

FIG. 6 illustrates an example scenario in which a UE communicates with a DU of a RAN while in an inactive state, but in which the base station retrieves context for the UE from another base station as part of the SDT communication;

FIG. 7A is a flow diagram of an example method for determining whether to perform an SDT or RRC resume procedure based on whether the UE supports RA-SDT communication, implemented in a UE;

FIG. 7B is a flow diagram of an example method similar to that of FIG. 7A, but in which the determination is based on whether the RAN supports RA-SDT communication, implemented in a UE;

FIG. 7C is a flow diagram of an example method similar to that of FIG. 7A, but in which the determination is based on whether the UE and RAN support RA-SDT communication, implemented in a UE;

FIG. 8 is a flow diagram of an example method for determining whether to perform an SDT or RRC resume procedure based on whether the UE and/or RAN support RA-SDT communication and whether conditions for initiating RA-SDT communication are met, implemented in a UE;

FIG. 9 is a flow diagram of an example method for determining whether to perform an SDT or RRC resume procedure based on whether the UE and/or RAN support RA-SDT communication and whether conditions for initiating RA-SDT and/or CG-SDT communication are met, implemented in a UE;

FIG. 10 is a flow diagram of an example method for performing CG-SDT communication in accordance with a CG-SDT configuration and subsequently perform a random access procedure during the CG-SDT communication, implemented in a UE;

FIG. 11 is a flow diagram of an example method for determining whether RA-SDT is configured based on whether the UE supports RA-SDT communication and whether conditions for initiating RA-SDT communication are met, implemented in a UE;

FIG. 12 is a flow diagram of an example method for determining whether to include SDT data in an data packet based on whether the UE and/or RAN support RA-SDT communication, implemented in a UE;

FIG. 13 is a flow diagram of an example method for determining whether to transmit a data packet using a configured grant or a dynamic grant based on whether the UE performs a random access procedure during CG-SDT communication, implemented in a UE;

FIG. 14 is a flow diagram of an example method for managing small data transmission with a UE, implemented in a UE; and

FIG. 15 is a flow diagram of an example method for managing small data transmission with a UE, implemented in a UE.

### DETAILED DESCRIPTION OF THE DRAWINGS

As discussed in more detail below, a user equipment (UE) and/or a network node of a radio access network (RAN) can use the techniques of this disclosure for managing early/small data communication and transitioning a UE between states of a protocol for controlling radio resources between the UE and the RAN. As used in this disclosure, small data communication can refer to small data transmission (SDT) from the perspective of the network (i.e., SDT in the downlink direction), or SDT from the perspective of the UE (i.e., SDT in the uplink direction).

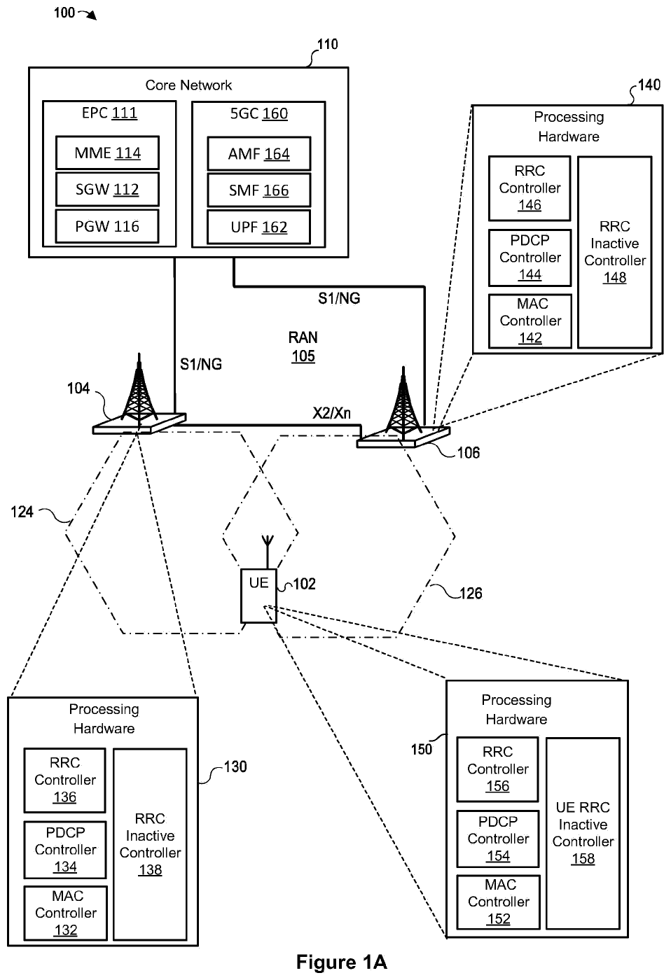

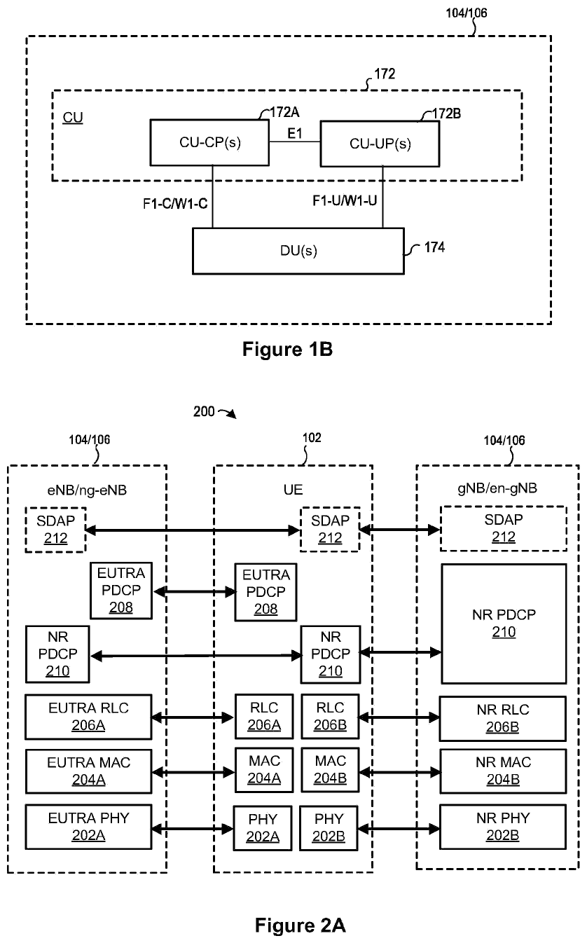

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the terms “data” or “data packet” refer to signaling, control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). Some non-signaling, non-control-plane information may be called user-plane data. The data to which the UE 102 and/or the RAN 105 applies the techniques of this disclosure can include, for example, Internet of Things (IoT) data, ethernet traffic data, internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to an RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID is an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 generates a message authentication code for integrity (MAC-I) to protect integrity of the data. Thus, the UE 102 in this case generates a security-protected packet including the data and the MAC-I. When encryption is enabled, the UE 102 encrypts the data to obtain an encrypted packet, so that the security-protected packet includes encrypted data. When both integrity protection and encryption are enabled, the UE 102 generates a MAC-I for protecting integrity of the data and encrypts the data along with the MAC-I to generate an encrypted packet and an encrypted MAC-I. The UE 102 then transmits the security-protected packet to the RAN 105 while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which, depending on the implementation, is associated with the medium access control (MAC) layer. Thus, the UE 102 in such cases transmits the secured UL PDCP PDU in the UL MAC PDU. In some implementations, the UE 102 includes, in the UL MAC PDU, a UL RRC message. In further implementations, the UE 102 does not include a UL RRC message in the UL MAC PDU. In some such cases, the UE 102 does not include a UE ID of the UE 102 in the UL MAC PDU not including a UL RRC message. In yet further implementations, the UE 102 includes the UL PDCP PDU in a UL radio link control (RLC) PDU and then includes the UL RLC PDU in the UL MAC PDU. In some implementations where the UE 102 includes the UL RRC message in the UL MAC PDU, the UE 102 generates an RRC MAC-I and includes the RRC MAC-I in the UL RRC message. For example, the RRC MAC-I is a resumeMAC-I field, as specified in 3GPP specification 38.331. In further implementations, the UE obtains the RRC MAC-I from the UL RRC message with an integrity key (e.g., K_{RRCint} key), an integrity protection algorithm, and/or other parameters COUNT (e.g., 32-bit, 64-bit or 128-bit value), BEARER (e.g., 5-bit value), and DIRECTION (e.g., 1-bit value). In some implementations, the UE sets bits for COUNT, BEARER, and DIRECTION to binary ones to generate the RRC MAC-I.

In further implementations, the data is a UL service data unit (SDU) of the NAS. The UE 102 applies the security function to the SDU and includes the secured SDU in a first UL PDU such as a NAS PDU, which can be associated with the NAS layer. For example, depending on the implementation, the NAS layer is an MM sublayer or SM sublayer of 5G, Evolved Packet System (EPS), or 6G. Then, in some implementations, the UE 102 includes the UL NAS PDU in a second UL PDU such as a UL RRC message. Thus, the UE 102 in such cases transmits the (first) secured UL NAS PDU in the UL RRC message. In some implementations, the UE 102 includes the UL RRC message in a UL MAC PDU and transmits the UL MAC PDU to a base station (e.g., base station 104 or 106) via a cell (e.g., cell 124 or 126). In this case, the UE 102 does not include an RRC MAC-I in the UL RRC message. Alternatively, the UE 102 includes an RRC MAC-I as described above.

In some implementations, the UL RRC message described above is a common control channel (CCCH) message, an RRC resume request message, or an RRC early data request message. In further implementations, the UL RRC message includes a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 retrieves the UE ID of the UE 102 from the UL RRC message and identifies the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies a number of security functions to decrypt the data and/or check the integrity protection, and transmits the data to the CN 110 (e.g., SGW 112, UPF 162, MME 114 or AMF 164) or an edge server. In some implementations, the edge server operates within the RAN 105. More specifically, the base station 104 derives at least one security key from UE context information of the UE 102. Then the base station 104 retrieves the data from the security-protected packet by using the at least one security key and transmits the data to the CN 110 or edge server.

When the security-protected packet is an encrypted packet, the base station 104 decrypts the encrypted packet to obtain the data by using the at least one security key (e.g., an encryption and/or decryption key). In some implementations, if the security-protected packet is an integrity-protected packet, the integrity-protected packet includes the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. In further implementations, if the security-protected packet is both encrypted and integrity-protected, the encrypted and integrity-protected packet includes the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In further implementations, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key).

In some implementations, if the security-protected packet is an integrity-protected packet, the integrity protected packet includes the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, in implementations where the security-protected packet is both encrypted and integrity-protected, the encrypted and integrity-protected packet include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 retrieves the UE ID of the UE 102 from the UL RRC message and identifies that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 applies at least one security function to the data to generate a security-protected packet, a first DL PDU including the security-protected packet, and the first DL PDU in a second DL PDU. Depending on the implementation, to secure the data, the base station 104 applies the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, in implementations where both integrity protection and encryption are enabled, the base station 104 generates a MAC-I for protecting the integrity of the data and encrypts the data along with the MAC-I to generate an encrypted packet and an encrypted MAC-I. The base station 104, in some implementations, generates a first DL PDU, such as a DL PDCP PDU, using the security-protected packet; includes the first DL PDU in a second DL PDU associated with the MAC layer, for example (e.g., a DL MAC PDU); and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU, and transmits the DL MAC PDU to the UE 102 without first causing the UE 102 to transition from the RRC_INACTIVE or RRC_IDLE state to the RRC_CONNECTED state.

In further implementations, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet further implementations, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU that the base station generates. In some implementations, the ID of the UE 102 can be a Radio Network Temporary Identifier (RNTI). For example, depending on the implementation, the RNTI is a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station assigns the ID of the UE 102 to the UE 102 in a random access response or a message B (MsgB) that the base station transmits in a random access procedure with the UE 102 before transmitting the DCI and scrambled CRC. In further implementations, the base station assigns the ID of the UE 102 to the UE 102 in an RRC message (e.g., RRC release message or an RRC reconfiguration message) that the base station transmits to the UE 102 before transmitting the DCI and scrambled CRC, such as while the UE 102 was in the RRC_CONNECTED state.

In some implementations, the UE 102 operating in the RRC_INACTIVE or RRC_IDLE state receives the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Further, in implementations where the security-protected packet is both encrypted and integrity-protected, with encrypted data and an encrypted MAC-I, the UE 102 decrypts the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base stations 104, 106 include a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 includes a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 includes a logical node CU-CP 172A that hosts the control plane part of the PDCP protocol of the CU 172. In further implementations, the CU 172 includes a logical node CU-UP 172B that hosts the user plane part of the PDCP protocol and/or Service Data Adaptation Protocol (SDAP) protocol of the CU 172. Depending on the implementation, the CU-CP 172A transmits control information (e.g., RRC messages, F1 application protocol messages), and the CU-UP 172B transmits the data packets (e.g., SDAP PDUs or Internet Protocol packets).

The CU-CP 172A can connect to multiple CU-UP 172B through the E1 interface. The CU-CP 172A selects the appropriate CU-UP 172B for the requested services for the UE 102. In some implementations, a single CU-UP 172B connects to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 connects to multiple CU-UP 172B under the control of the same CU-CP 172A. In such implementations, the CU-CP 172A establishes the connectivity between a CU-UP 172B and a DU 174 by using Bearer Context Management functions.

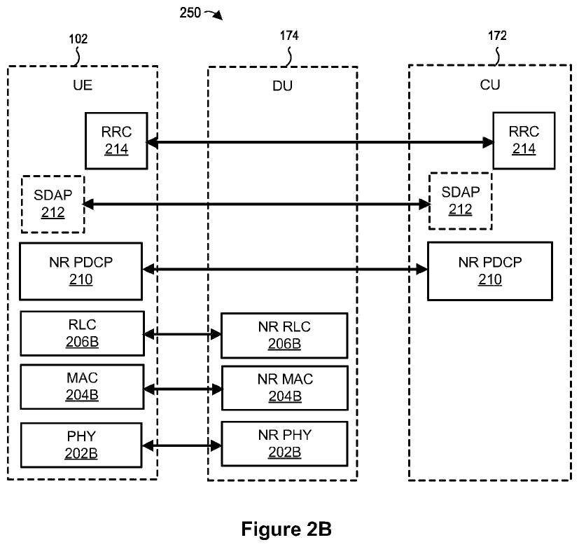

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. In some implementations, the NR PDCP sublayer 210 then provides data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

In some implementations, on a control plane, the EUTRA PDCP sublayer 208 and the NR PDCP sublayer 210 provides signaling radio bearers (SRBs) or RRC sublayer (not shown in FIG. 2A) to exchange RRC messages or non-access-stratum (NAS) messages, for example. In further implementations, on a user plane, the EUTRA PDCP sublayer 208 and the NR PDCP sublayer 210 provides Data Radio Bearers (DRBs) to support data exchange. Data exchanged on the NR PDCP sublayer 210 can be SDAP PDUs, Internet Protocol (IP) packets, or Ethernet packets.

FIG. 2B illustrates, in a simplified manner, an example protocol stack 250, via which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

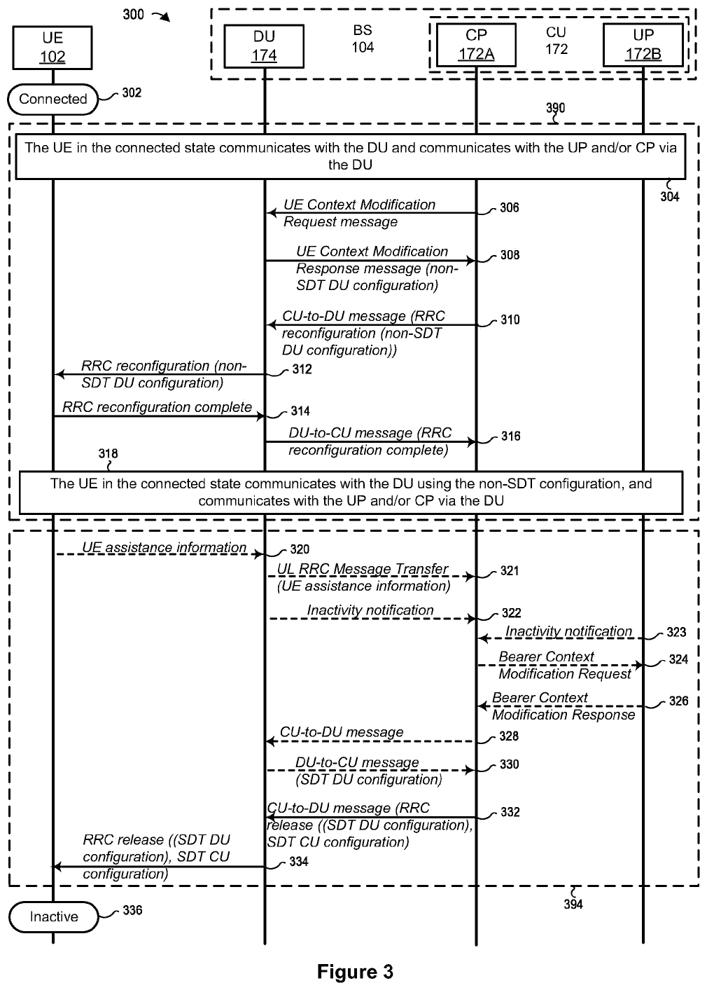

Next, several example scenarios that involve several components of FIG. 1A and relate to transmitting data in an inactive or idle state are discussed next with reference to FIGS. 3-6. To simplify the following description, the “inactive state” is used and can represent the RRC_INACTIVE or RRC_IDLE state, and the “connected state” is used and can represent the RRC_CONNECTED state.

Referring first to FIG. 3, which illustrates a scenario 300, in which the base station 104 includes a central unit (CU) 172 and a distributed unit (DU) 174. The CU 172 further includes a CU-CP 172A and a CU-UP 172B. In the scenario 300, the UE 102 initially operates in a connected state 302 and communicates 304 with the DU 174, such as by using a DU configuration (i.e., a first non-SDT DU configuration). The UE 102 further communicates 304 with the CU-CP 172A and/or CU-UP 172B via the DU by using a CU configuration (i.e., a first non-SDT CU configuration). While the UE communicates 304 with the base station 104, the CU-CP 172A can send 306 a UE Context Modification Request message. In response, the DU 174 sends 308 a UE Context Modification Response message including a non-SDT configuration (i.e., a second non-SDT configuration) for the UE 102 to the CU-CP 172A. The CU-CP 172A generates an RRC reconfiguration message including the second non-SDT DU configuration and transmits 310 a first CU-to-DU message (e.g., DL RRC Message Transfer message) including the RRC reconfiguration message to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the second non-SDT DU configuration. The UE 102 further communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration.

In some implementations, the second non-SDT CU configuration modifies or augments the first non-SDT CU configuration or includes at least one new configuration parameter not included in the first non-SDT CU configuration. In such cases, the UE 102 and at least one of the CU-CP 172A and/or the CU-UP 172B can communicate 318 with one another using the second non-SDU CU configuration as well as configuration parameters in the first non-SDT CU configuration that the second non-SDU CU configuration does not modify or augment. In some implementations, the first non-SDT CU configuration includes configuration parameters related to operations of RRC and/or PDCP protocol layers (e.g., RRC 214 and/or NR PDCP 210), that the UE 102 and CU 172 use to communicate with one another while the UE 102 operates in the connected state. Similarly, in further implementations, the second non-SDT CU configuration includes configuration parameters related to operations of the RRC and/or PDCP protocol layers, that the UE 102 and CU 172 use to communicate with one another while the UE 102 operates in the connected state.

In some implementations, the first non-SDT CU configuration includes configuration parameters in a RadioBearerConfig information element (IE) and/or MeasConfig IE defined in 3GPP specification 38.331 v16.7.0 or later. Similarly, the second non-SDT CU configuration includes configuration parameters in the RadioBearerConfig IE and/or MeasConfig IE defined in 3GPP specification 38.331 v16.7.0 or later. In some implementations, the first non-SDT CU configuration can be or include a RadioBearerConfig IE and/or a MeasConfig IE, and the second non-SDT CU configuration can be or include a RadioBearerConfig IE and/or MeasConfig IE.

In some implementations, the first non-SDT DU configuration includes configuration parameters related to operations of RRC, RLC, MAC, and/or PHY protocol layers (e.g., RLC 206B, MAC 204B and/or PHY 202B), that the UE 102 and DU 174 use to communicate with one another while the UE 102 operates in the connected state. Similarly, the second non-SDT DU configuration can include configuration parameters related to operations of the RRC, RLC, MAC, and/or PHY protocol layers, that the UE 102 and DU 174 use to communicate with one another while the UE 102 operates in the connected state.

In some implementations, the first non-SDT DU configuration includes configuration parameters in a CellGroupConfig IE defined in 3GPP specification 38.331 v16.7.0 or later. Similarly, the second non-SDT DU configuration includes configuration parameters in the CellGroupConfig IE defined in 3GPP specification 38.331 v16.7.0 or later. In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource (re) configuration procedure 390, which can be optional.

While the UE 102 communicates with the base station 104 or after the non-SDT resource configuration/reconfiguration procedure 390 (if performed), the CU-CP 172A can determine to cause the UE 102 to transition to an inactive state from the connected state, based on data inactivity of the UE 102 (i.e., the UE 102 in the connected state has no data activity with the base station 104). In some implementations, either while the UE 102 communicates with the base station 104 or after the non-SDT resource configuration/reconfiguration procedure 390 (if performed), the UE 102 determines or detects data inactivity and transmits 320, to the DU 174, UE assistance information (e.g., a UEAssistanceInformation message) indicating that the UE 102 prefers or requests to transition to the inactive state or leave the connected state. In some implementations, the UE 102 indicates, in the UE assistance information, that the UE 102 prefers or requests to transition to the inactive state with SDT configured. In turn, the DU 174 transmits 321 a UL RRC Message Transfer message including the UE assistance information to the CU-CP 172A. Thus, the CU-CP 172A can determine that the UE 102 has data inactivity based on the UE assistance information.

In other implementations, the DU 174 performs data inactivity monitoring for the UE 102. The CU-CP 172A can transmit (not shown) a CU-to-DU message (e.g., a UE Context Setup Request message or a UE Context Modification Request message) to the DU 174 to request or command the DU 174 to perform the data inactivity monitoring. In cases where the DU 174 detects or determines that the UE 102 has data inactivity during the monitoring, the DU 174 can transmit 322 an inactivity notification (e.g., UE Inactivity Notification message) to the CU-CP 172A. Thus, the CU-CP 172A can determine that the UE 102 has data inactivity based on the inactivity notification received from the DU 174.

In yet other implementations, the CU-UP 172B performs data inactivity monitoring for the UE 102. The CU-CP 172A can transmit (not shown) a CP-to-UP message (e.g., a Bearer Context Setup Request message or a Bearer Context Modification Request message) to the CU-UP 172B to request or command the CU-UP 172B to perform the data inactivity monitoring. In cases where the CU-UP 172B detects or determines that the UE 102 has data inactivity during the monitoring, the CU-UP 172B can transmit 323 an inactivity notification (e.g., Bearer Context Inactivity Notification message) to the CU-CP 172A. Thus, the CU-CP 172A can determine that the UE 102 has data inactivity based on the inactivity notification received from the CU-UP 172B. In some implementations, the CU-CP 172A determines that the UE 102 has data inactivity based on the UE assistance information from events 320, 321, inactivity notification of the event 322, and/or inactivity notification of the event 323.

In some implementations, after a certain period of data inactivity, the CU-CP 172A determines that neither the CU 172 (i.e., the CU-CP 172A and/or the CU-UP 172B) nor the UE 102 has transmitted any data in the downlink direction or the uplink direction, respectively, during the certain period. In response to the determination, the CU-CP 172A can determine to cause the UE 102 to transition to the inactive state with SDT configured. Alternatively, the CU-CP 172A can determine to cause the UE 102 to transition to the inactive state without SDT configured in response to determining that the UE 102 has data inactivity.

In response to or after determining that the UE 102 has data inactivity (for a certain period) or determining to cause the UE 102 to transition to the inactive state with SDT configured, the CU-CP 172A sends 324 to the CU-CP 172B a Bearer Context Modification Request message to suspend data transmission for the UE 102. In response, the CU-UP 172B suspends data transmission for the UE 102 and sends 326 a Bearer Context Modification Response message to the CU-CP 172A. In some implementations, in response to or after determining that the UE 102 has data inactivity (for the certain period) or determining to cause the UE 102 to transition to the inactive state with SDT configured, the CU-CP 172A sends 328 a second CU-to-DU message (e.g., a UE Context Modification Request message) to instruct the DU 174 to provide an SDT DU configuration for the UE 102. In some implementations, the CU-CP 172A includes an SDT request indication (e.g., an IE such as a CG-SDT Query Indication IE or SDT Query Indication IE) to request an SDT DU configuration in the second CU-to-DU message.

In further implementations, in response to the SDT request indication or the second CU-to-DU message, the DU 174 transmits 330 a second DU-to-CU message (e.g., UE Context Modification Response message) to the CU-CP 172A. Alternatively, the DU 174 does not include the SDT DU configuration in the second DU-to-CU message. Instead, the DU 174 sends (not shown), to the CU-CP 172A, an additional DU-to-CU message (e.g., UE Context Modification Required message) including the SDT DU configuration, after receiving the second CU-to-DU message or transmitting the second DU-to-CU message. In some implementations, the CU-CP 172A transmits (not shown) an additional CU-to-DU message (e.g., UE Context Modification Confirm message) to the DU 174 in response to the additional CU-to-DU message.

In other implementations, the CU-CP 172A transmits 328 the second CU-to-DU message and receives 330 the second DU-to-CU message or the additional DU-to-CU message, before determining that the UE 102 has data inactivity. In yet other implementations, the CU-CP 172A includes the SDT request indication in the first CU-to-DU message of the event 308 and the DU 174 includes the SDT DU configuration in the first DU-to-CU message of the event 310 in response to the SDT request indication.

Depending on the implementation, in response to determining to cause the UE 102 to transition to the inactive state with SDT configured, the CU-CP 172A generates an RRC release message (e.g., RRCRelease message RRCConnectionRelease message) to cause the UE 102 to transition to the inactive state. The CU-CP 172A can include the SDT DU configuration (if obtained from the DU 174) and/or an SDT CU configuration in the RRC release message. The CU-CP 172A then sends 332 to the DU 174 a third CU-to-DU message (e.g., a UE Context Release Command message, a UE Context Modification Request message or a DL RRC Message Transfer message) which includes the RRC release message. In turn, the DU 174 transmits 334 the RRC release message to the UE 102. In some implementations, the DU 174 generates a MAC PDU including the RRC release message and transmits 334 the MAC PDU to the UE 102. The RRC release message instructs the UE 102 to transition to the inactive state. The UE 102 transitions 336 to the inactive state from the connected state upon receiving the RRC release message. Depending on the implementation, in response to the third CU-to-DU message, the DU 174 retains the SDT DU configuration (if generated by the DU 174 during the procedure 328, 330) and can release or retain (a portion of) the first non-SDT DU configuration and/or (a portion of) second non-SDT DU configuration. The DU 174 can send (not shown) a third DU-to-CU message (e.g., a UE Context Release Complete message or a UE Context Modification Response message) to the CU-CP 172A in response to the third CU-to-DU message.

In some implementations, the UE 102 monitors a PDCCH using a C-RNTI to receive a DCI, while operating 302 in the connected state. In response to or after receiving 334 the RRC release message, the UE 102 stops using the C-RNTI to monitor a PDCCH. In some implementations, the UE 102 retains the C-RNTI in response to or after receiving 334 the RRC release message or transitioning 336 to the inactive state from the connected state. In some implementations, the UE 102 performs a two-step or a four-step random access procedure with the base station 104 (e.g., the CU-CP 172A and/or DU 174) and receives from the DU 174 a random access response message, including the C-RNTI in the random access procedure. In other implementations, the UE 102 receives an RRC message (e.g., RRC reconfiguration message) including the C-RNTI from the CU-CP 172A via the DU 174 or another base station (e.g., base station 106) not shown in FIG. 3.

The events 320 (optional), 321 (optional), 322 (optional), 323, 324, 326, 328, 330, 332 and 334 are collectively referred to in FIG. 3 as an SDT configuration procedure 394.

In some implementations, the UE 102 releases the first non-SDT DU configuration and/or second non-SDT DU configuration in response to the RRC release message. In further implementations, the UE 102 releases at least a portion of the first non-SDT DU configuration and at least a portion of the second non-SDT DU configuration in response to the RRC release message. In other implementations, if the RRC release message instructs the UE 102 to transition to the idle state (i.e., RRC_IDLE), the UE 102 releases the first non-SDT DU configuration and/or second non-SDT configuration. In yet other implementations, if the RRC release message instructs the UE 102 to transition to the inactive state (i.e., RRC_INACTIVE), the UE 102 releases a first portion of the first and/or second non-SDT DU configurations and retains a second portion of the first and/or second non-SDT DU configurations. In still other implementations, if the RRC release message instructs the UE 102 to transition to the inactive state (i.e., RRC_INACTIVE), the UE 102 retains the first non-SDT DU configuration (not augmented by the second non-SDT DU configuration if received) and/or second non-SDT DU configuration.

In some implementations, the CU-CP 172A does not include an indication in the third CU-to-DU message to instruct the DU 174 to retain the SDT DU configuration. The DU 174 retains the SDT DU configuration as described above by default. In other implementations, the CU-CP 172A includes an indication in the third CU-to-DU message (e.g., a UE Context Release Command message) to instruct the DU 174 to retain the SDT DU configuration, and the DU 174 retains the SDT DU configuration in response to the indication. If the UE Context Release Command message excludes the indication, the DU 174 releases the SDT DU configuration. In yet other implementations, the CU-CP 172A does not include an indication in the third CU-to-DU message (e.g., a UE Context Modification Request message or a DL RRC Message Transfer message) for the UE 102 to instruct the DU 174 to release the SDT DU configuration. Thus, the DU 174 retains the SDT DU configuration in response to the third CU-to-DU message excluding the indication. If the third CU-to-DU message includes the indication, the DU 174 releases the SDT DU configuration.

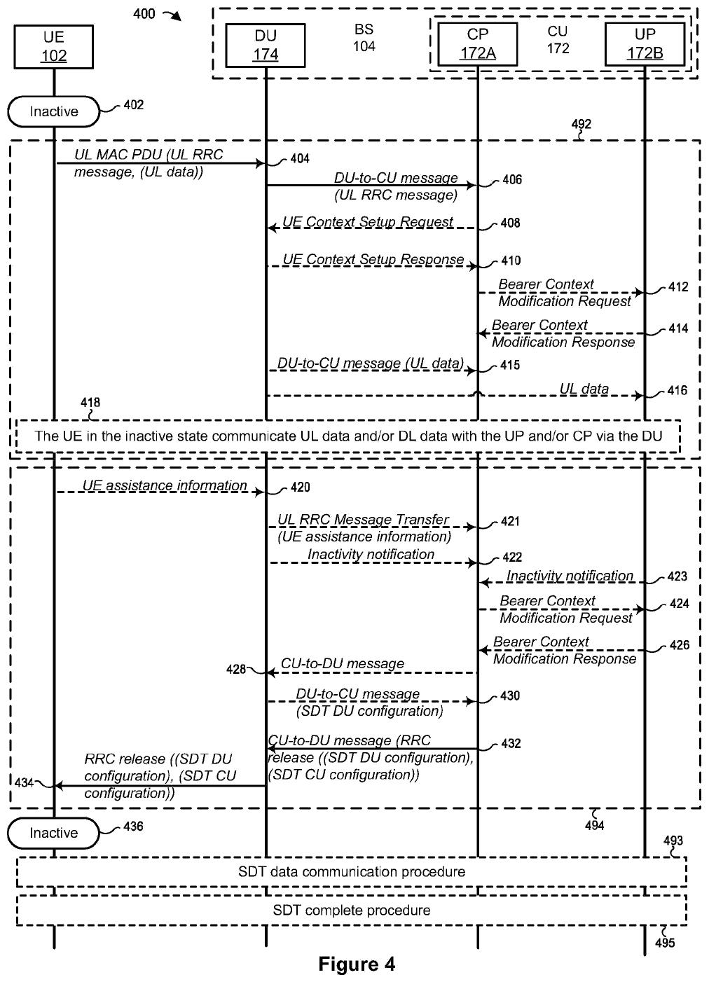

In some implementations, the SDT CU configuration (e.g., SDT-Config IE) includes a DRB list (e.g., a std-DRB-List) including a list of DRB ID(s) that indicate ID(s) of DRB(s) configured for SDT. In some implementations, the SDT CU configuration can include an SRB2 indication (e.g., sdt-SRB2-Indication) that indicates an SRB2 configured for SDT. In some implementations, the SDT CU configuration includes a compression protocol continue indication (e.g., sdt-DRB-ContinueROHC) that indicates whether a PDCP entity for the DRB(s) configured for SDT, during SDT operation (i.e., initial and/or subsequent SDT described for FIG. 4) continues. For example, the compression protocol can be a Robust Header Compression (ROHC). In some implementations, the SDT CU configuration includes a data volume threshold (e.g., sdt-DataVolumeThreshold) for the UE 102 to determine whether the UE 102 can initiate SDT. In some implementations, the CU-CP 172A includes the SDT DU configuration in the SDT CU configuration. In some implementations, “SDT CU configuration” is simplified to “SDT configuration”.

In some implementations, the SDT DU configuration includes at least one of a buffer status reporting (BSR) configuration, a power headroom reporting (PHR) configuration, configured grant (CG) configuration(s) for CG-SDT, a UL bandwidth part (BWP) configuration, a DL BWP configuration for CG-SDT, a time alignment timer value for CG-SDT (e.g., CG-SDT time alignment timer (CG-SDT-TAT) value), and/or a timing advance validity threshold for CG-SDT. In some implementations, the UL BWP configuration configures a dedicated UL BWP for the UE 102 to perform CG-SDT. Depending on the implementation, the UL BWP configuration includes the CG configuration(s), a PUCCH configuration, a PUSCH configuration and/or a sounding reference signal (SRS) configuration. In some implementations, the DL BWP configuration configures a dedicated DL BWP for the UE 102 during CG-SDT. In some implementations, the DL BWP configuration includes a PDCCH configuration and/or a PDSCH configuration for the UE to receive DL control signals on PDCCH(s) and data on PDSCH(s) from the DU 174 while the UE 102 performs CG-SDT with the DU 174. Each of the CG configuration(s) configures periodic radio resources (i.e., CG resources) that the UE 102 can use to transmit data without receiving a dynamic grant for data transmission. Each of the CG configuration(s) configures or includes a periodicity indicating that CG resources periodically occur. In some implementations, the periodicity is a fixed number of symbols, slots or subframes. Depending on the implementation, some or all of the CG configuration(s) have the same periodicity or different periodicities.

In some implementations, each of the CG configuration(s) configures or includes an offset indicating a time domain offset (e.g., timeDomainOffset), related to a reference time (e.g., system frame number (SFN)), for the CG resources. In some implementations, the CG configuration configures or includes the reference time (e.g., timeReferenceSFN). In some implementations, the CG configuration is or is similar to a ConfiguredGrantConfig IE specified in 3GPP specification 38.331. The DU 174 configures the timing advance validity threshold (e.g., including a RSRP range) for the UE 102 to determine whether the UE 102 can initiate SDT using the configured grant configuration for CG-SDT as described for FIG. 4. In accordance with the timing advance validity threshold, the UE 102 evaluates whether a stored timing advance value is still valid. In implementations where the UE 102 determines that the stored timing advanced value is invalid, the UE 102 initiates an RA-SDT with the CU 172 via the DU 174 as described for FIG. 4. In some implementations, the SDT DU configuration is an SDT-MAC-PHY-CG-Config IE or SDT-MAC-PHY-Config IE.

In some implementations, the “SDT DU configuration” is replaced by “CG-SDT configuration(s)”. In such implementations, the configurations in the SDT DU configuration are specific for CG-SDT. In other implementations, some of the configuration(s) in the SDT DU configuration described above are part of the CG-SDT configuration(s) and the other configuration(s) (e.g., the BSR configuration and/or PHR configuration) in the SDT DU configuration are not within the CG-SDT configuration(s). The SDT DU configuration includes the CG-SDT configuration(s). In such cases, the UE 102 configures the other configuration(s) for CG-SDT or RA-SDT. In other implementations, the “SDT DU configuration” is simplified to “SDT configuration”.

In some implementations, the DU 174 starts or restarts a DU CG-SDT timer in response to or after: receiving the SDT request indication, generating the CG-SDT configuration(s), receiving 328 the second CU-to-DU message, transmitting 330 the CG-SDT configuration(s) to the CU 172, receiving 332 the third CU-to-DU message, or transmitting 334 the CG-SDT configuration(s) to the UE 102. In further implementations, the DU 174 starts or restarts the DU CG-SDT timer with a timer value to manage the CG-SDT configuration(s).

In some implementations, the timer value is the same as the CG-SDT time alignment timer value. In other implementations, the timer value is close to the CG-SDT time alignment timer value. For example, the timer value can be larger than and close to the CG-SDT time alignment timer value. In another example, the timer value can be smaller than and close to the CG-SDT time alignment timer value. In cases where the DU CG-SDT timer expires, the DU 174 releases the CG-SDT configuration(s) or the CG resources configured in the CG-SDT configuration(s). When or after releasing the CG-SDT configuration(s), the DU 174 refrains from receiving PUSCH transmissions from the UE 102 on the radio resources that the RAN 105 reserved or configured for the CG-SDT configuration(s). In some implementations, when or after releasing the CG-SDT configuration(s), the DU 174 schedules transmissions for other UE(s) on the radio resources that were reserved or configured for the CG-SDT configuration(s).

As described above, the RRC release message 334, in some implementations, includes the CG-SDT configuration(s). The UE 102 starts or restarts a UE CG-SDT timer (e.g., CG-SDT-TAT) in response to or after receiving the CG-SDT configuration(s). In some implementations, the UE 102 starts or restarts the UE CG-SDT timer (i.e., a first UE CG-SDT timer) with the CG-SDT time alignment timer value, in response to or after receiving the CG-SDT configuration(s). In some cases where the UE CG-SDT timer expires, the UE 102 releases the CG-SDT configuration(s). In other cases where the UE CG-SDT timer expires, the UE 102 alternatively retains the CG-SDT configuration(s) and refrains from transmitting UL transmissions (e.g., MAC PDUs) on the CG resources. In some such instances, the UE 102 releases the CG resources or determines that the CG resources are not valid. Depending on the implementation, when the UE CG-SDT timer expires, the UE 102 releases the SRS configuration or SRS resources configured in the SRS configuration. Alternatively, when the UE CG-SDT timer expires, the UE 102 retains the SRS configuration and refrains from transmitting one or more SRSs to the DU 174 on the SRS resources.

While the UE CG-SDT timer is running, the UE 102 in the inactive state communicates (e.g., performs CG-SDT, transmits SRS(s), and/or receives DL control signals (e.g., DCI) and/or data) with the DU 174 via the dedicated DL BWP and dedicated UL BWP. In some implementations, when the UE CG-SDT timer expires, the UE 102 in the inactive state switches to an initial DL BWP and an initial UL BWP from the dedicated DL BWP and dedicated UL BWP, respectively. In some such cases, the UE 102 retunes transceivers of the UE 102 to switch to the initial DL BWP and initial UL BWP. In some implementations, the UE 102 in the inactive state switches to the initial DL BWP and initial UL BWP to perform a random access procedure, while the RAN 105 configures the UE 102 with the CG-SDT configuration. Depending on the implementation, the UE 102 performs the random access procedure for different cases as described below. In some implementations, the UE 102 in the inactive state switches to the initial DL BWP and initial UL BWP to perform measurements on SSBs that the DU 174 transmits on the initial DL BWP.

In some implementations, the DU 174 or CU-CP 172A configures the dedicated DL BWP and dedicated UL BWP to be the same as or include the initial DL BWP and initial UL BWP, respectively. In some such implementations, when the UE CG-SDT timer expires, the UE 102 does not switch to the initial DL BWP and initial UL BWP from the dedicated DL BWP and dedicated UL BWP, respectively. In further such cases, the UE 102 does not retune transceivers of the UE 102 due to switching BWPs. In yet further such cases, when the UE 102 in the inactive state performs a random access procedure with the DU 174, the UE 102 performs the random access procedure without switching to the initial DL BWP and initial UL BWP. In such cases, the UE 102 performs measurements on SSBs that the DU 174 transmits within the initial DL BWP, while performing CG-SDT with the DU 174.

In some implementations, in response to or after the UE CG-SDT timer expires, the UE 102 performs RA-SDT with the CU 172 via the DU 174 on the initial UL BWP and initial DL BWP, as described for FIG. 4. That is, the UE 102 determines that RA-SDT is valid in response to or after the UE CG-SDT timer expires.

In some implementations, the DU 174 reserves CG resources configured in the CG configuration(s). In further implementations, the DU 174 releases the CG resources when releasing either the SDT DU configuration or the CG-SDT configuration(s), or when the DU CG-SDT timer expires. In some implementations, the DU 174 releases the SRS resources configured in the SRS configuration when releasing either the SDT DU configuration or the CG-SDT configuration(s), or when the DU CG-SDT timer expires.

In cases where the DU 174 does not provide the CG-SDT configuration(s) or the SDT DU configuration to the CU-CP 172A, the DU 174 releases all signaling and user data transport resources for the UE 102 in response to the third CU-to-DU message. In cases where the DU 174 provides the SDT DU configuration or the CG-SDT configuration(s) to the CU-CP 172A, the DU 174 retains signaling and user data transport resources for the UE 102 in response to or after receiving the third CU-to-DU message.

In cases where the SDT DU configuration does not include a configuration for CG-SDT, the CU-CP 172A and/or the DU 174 only configures RA-SDT for the UE 102. In some such cases, the UE 102 performs RA-SDT with the CU 172 via the DU 174 as described for FIG. 4.

In some implementations, the CU-CP 172A does not request the DU 174 to provide an SDT DU configuration when determining to cause the UE 102 to transition to the inactive state with SDT configured. In some such cases, the events 328 and 330 are omitted, and the CU-CP 172A does not include the SDT DU configuration in the RRC release message. Alternatively, the CU-CP 172A generates the SDT DU configuration by itself without requesting the DU 174 to provide an SDT DU configuration, and includes the SDT DU configuration in the RRC release message.

In some implementations, the DU 174 does not include an SDT DU configuration in the second DU-to-CU message. In some such implementations, the DU 174 does not include the SDT DU configuration in the second DU-to-CU message because the UE 102 does not support CG-SDT, and the DU 174 therefore does not support CG-SDT. In other implementations, the DU 174 does not include the SDT DU configuration in the second DU-to-CU message because the DU 174 does not have available radio resources for CG-SDT. In such cases, the RRC release message does not include an SDT DU configuration. Otherwise, the DU 174 transmits an SDT DU configuration to the CU-CP 172A as described above.

In some implementations, the DU 174 does not include a configuration for CG-SDT in the SDT DU configuration in the second DU-to-CU message. In some such implementations, the DU 174 does not include the configuration for CG-SDT because the UE 102 does not support CG-SDT, and the DU 174 therefore does not support CG-SDT. In other implementations, the DU 174 does not include the configuration for CG-SDT because the DU 174 does not have available radio resources for CG-SDT. In such cases, the SDT DU configuration does not include a CG-SDT configuration. Otherwise, the DU 174 includes the CG-SDT configuration(s) in the SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. Depending on the implementation, the CU-CP 172A receives a UE capability (e.g., UE-EUTRA-Capability IE, UE-NR-Capability IE, or UE-6G-Capability IE) for the UE 102 from the UE 102, the CN 110 (e.g., MME 114 or AMF 164), or the base station 106, while the UE 102 operates 302 in the connected state. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message defined in 3GPP specification 38.473).

In some implementations, the DU 174 determines whether to provide an SDT DU configuration for the UE 102 to the CU-CP 172A, depending on whether the UE 102 supports CG-SDT or not. In further implementations, the DU 174 additionally determines whether to provide an SDT DU configuration for the UE 102 to the CU-CP 172A, depending on whether the DU 174 supports CG-SDT or not. In cases where the UE 102 supports CG-SDT and/or the DU 174 supports CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). In some implementations, the DU 174 receives the UE capability from the CU-CP 172A while the UE 102 operates 302 in the connected state or in the inactive state before the event 302. Thus, the DU 174 can determine whether the UE supports CG-SDT in accordance with the UE capability. In some implementations, the DU 174 sends a DU-to-CU message to the CU-CP 172A to indicate whether the DU 174 does support CG-SDT or not, as described above.

Referring now to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, the UE 102 transitions to the inactive state from the connected state with SDT configured, as described for FIG. 3. In such implementations, the UE receives a first SDT CU configuration and/or a first SDT DU configuration in an RRC release message (e.g., event 334). In other implementations or scenarios, the UE 102 transitions to the inactive state with SDT configured from the inactive state without SDT configured. For example, the UE 102 receives, from a base station (e.g., the base station 104 or base station 106), an RRC release message causing the UE 102 to transition to the inactive state and not configuring SDT (e.g., indicating releasing SDT or not including an SDT configuration in the RRC release message). In this case, the UE 102 transitions to the inactive state without SDT configured in response to the RRC release message. The UE 102 in the inactive state, with or without SDT configured, performs a RAN notification area (RNA) update with the base station without state transitions. During the RNA update, the UE 102 receives another RRC release message including a first SDT CU configuration and/or a first SDT DU configuration from the base station, similar to the RRC release message of the event 334.

Later in time, the UE 102, operating in the inactive state with SDT configured, initiates SDT. In response to or after initiating SDT, the UE 102 generates an initial UL MAC PDU, which includes a UL RRC message, and transmits 404 the initial UL MAC PDU to the DU 174 on a cell (e.g., the cell 124 or another cell of the base station 104 not shown in FIG. 1A). The following events between the UE 102 and the DU 174 occur on the cell. In some implementations, the UE 102 starts an SDT session timer in response to initiating the SDT. In some implementations, the SDT session timer is a new timer (e.g., T319a) defined in an RRC specification (e.g., v17.0.0). The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message is an Initial UL RRC Message Transfer message. In other implementations, the first DU-to-CU message is a UL RRC Message Transfer message.

In scenarios in which the UE 102 initiates SDT to transmit UL data (e.g., a data packet) qualifying for SDT, the UE 102 transmits 404 an initial UL MAC PDU including the UL data. In scenarios in which the UE 102 initiates SDT to receive DL data, the UE 102 transmits 404 an initial UL MAC PDU without an UL data packet. The UE 102 can initiate SDT to receive DL data in response to receiving (not shown) a paging message from the DU 174. In such scenarios, the UE 102 can include an SDT indication in the initial UL MAC PDU or the UL RRC message to indicate to the base station 104 that the UE 102 is initiating SDT to receive DL data.

In some implementations, the UE 102 in the inactive state performs a random access procedure with the DU 174 to transmit 404 the UL MAC PDU. In such cases, the SDT can be an RA-SDT. For example, the random access procedure can be a four-step random access procedure or a two-step random access procedure. In cases where the procedure is a four-step random access procedure, the UE 102 transmits a random access preamble to the DU 174 and, in response, the DU 174 transmits to the UE 102 a random access response (RAR) including a dynamic uplink grant, a temporary C-RNTI, and a timing advance command. The UE 102 then transmits 404 the UL MAC PDU to the DU 174 in accordance with the dynamic uplink grant. The DU 174 receives 404 the UL MAC PDU in accordance with the dynamic uplink grant in the RAR and transmits a DL MAC PDU including a contention resolution MAC control element to the UE 102 in response.

In cases where the procedure is a two-step random access procedure, the UE 102 transmits 404 to the DU 174 a message A (MsgA) including a random access preamble and the UL MAC PDU in accordance with two-step random access configuration parameters. The UE 102 receives a message B (MsgB) including a temporary C-RNTI and a timing advance command from the DU 174 in response to the MsgA. The DU 174 includes a contention resolution MAC control element in the MsgB. The UE 102 receives the two-step random access configuration parameters in system information broadcast by the DU 174 on the cell 124 before transmitting 404 the UL MAC PDU. The DU 174 receives 404 the UL MAC PDU in accordance with the two-step random access configuration parameters.

When the UE 102 successfully performs a contention resolution in the random access procedure (i.e., receives the contention resolution MAC control element), the UE 102 discards a previously retained C-RNTI (e.g., described for FIG. 3) and determines the temporary C-RNTI to be a C-RNTI (i.e., a new C-RNTI). The UE 102 monitors a PDCCH from the DU 174 using the C-RNTI to communicate 418 data (e.g., UL data and/or DL data) with the base station 104. In details, the UE 102 receives a DCI and a cyclic redundancy check (CRC) of the DCI on a PDCCH from the DU 174 and verifies the CRC using the C-RNTI. The DCI can include a dynamic uplink grant or a downlink assignment. If the UE 102 verifies the CRC is correct and the DCI includes a dynamic uplink grant, the UE 102 uses the dynamic uplink grant to transmit 418 UL data to the DU 174. If the UE 102 verifies the CRC is correct and the DCI includes a downlink assignment, the UE 102 uses the downlink assignment to receive 418 DL data from the DU 174. In some implementations, the DU 174 scrambles the CRC using the C-RNTI and the UE 102 verifies the scrambled CRC using the C-RNTI.

In other implementations, the UE 102 transmits 404 the UL MAC PDU on CG resources in cases where the UE 102 receives or the RAN 105 configures the UE 102 with CG configuration(s), as described for FIG. 3. In such cases, the UE 102 performs CG-SDT. The UE 102 does not perform a random access procedure for transmitting 404 the UL MAC PDU. Thus, the DU 174 receives 404 the UL MAC PDU on the CG resources. In some such implementations, after generating or transmitting 404 the UL MAC PDU, the UE 102 starts a UE timer (e.g., a second UE CG-SDT timer) if the CU-CP 172A or the DU 174 configures the UE 102 to apply the UE timer during SDT. In some implementations, the UE 102 starts the UE timer with a UE timer value (e.g., cg-SDT-RetransmissionTimer value). After transmitting 404 the UL MAC PDU, when the UE 102 receives a DCI and a CRC of the DCI on a PDCCH from the DU 174 and verifies that the CRC is correct using the C-RNTI, the UE 102 stops the UE timer. In some implementations, the DU 174 scrambles the CRC using the C-RNTI and the UE 102 verifies the scrambled CRC using the C-RNTI.

In further implementations, the UE 102 receives 434, 432 an RRC release message including the UE timer value from the base station 104, similar to the events 332, 334. The CU-CP 172A includes the UE timer value in a CG-SDT configuration and transmits the RRC release message including the CG-SDT configuration to the UE 102 via the DU 174. In other implementations, the UE 102 receives the UE timer value in a system information block broadcast by the DU 174 via the cell 124. While the UE timer is running, the UE 102 in the inactive state or SDT session refrains from retransmitting the UL MAC PDU on the CG resources. In some implementations, in response to or after receiving 404 the UL MAC PDU on the CG resources, the DU 174 starts a DU timer (e.g., a second DU CG-SDT timer) with a DU timer value. In some implementations, the DU timer value is the same as or larger than the UE timer value. While the DU timer is running, the DU 174 processes UL transmissions received from the UE 102 on the CG resources as new transmissions.

In some implementations, the UE 102 transmits 418 subsequent UL MAC PDU(s), including one or more UL data packets, on the CG radio resources. In further implementations, the UE 102 transmits 418 the subsequent UL MAC PDU (s,) on radio resources configured in dynamic uplink grant(s) received on PDCCH(s) from the DU 174. In some implementations, the UE 102 transmit 418 some of the subsequent UL MAC PDU(s) on radio resources configured in the CG configuration and transmits 418 the remainder of the subsequent UL MAC PDU(s) on radio resources configured in the dynamic uplink grant(s).

In some implementations where the UE 102 transmits 418 subsequent UL MAC PDU(s) on the CG resources, the UE 102 starts or restarts the timer (e.g., the second UE CG-SDT timer) after generating or transmitting 418 each of the subsequent UL MAC PDU(s). The UE 102 can start or restart the timer with the timer value as described above. While the UE timer runs, the UE 102 in either the inactive state or SDT session refrains from retransmitting the UL MAC PDU. In some implementations, in response to or after receiving 418 each of the subsequent UL MAC PDU(s) on the CG resources, the DU 174 starts or restarts the DU timer (e.g., the second DU CG-SDT timer) with the DU timer value. While the DU timer is running, the DU 174 processes UL transmissions received from the UE 102 on the CG resources as new transmissions. In other implementations, the DU 174 processes 404, 418 the UL MAC PDU(s) without starting the DU timer.

If the UE 102 includes UL data in the initial UL MAC PDU 404, the DU 174 retrieves the UL data from the initial UL MAC PDU. In some such cases, the DU 174 includes the UL data in the DU-to-CU message of the event 406. Alternatively, the DU 174 sends 415 a DU-to-CU message including the UL data to the CU-CP 172A. In such an alternative implementation, the UL data includes or is a PDCP PDU, an RRC PDU, NAS PDU, or an LTE positioning protocol (LPP) PDU. Depending on the implementation, the PDCP PDU includes an RRC PDU. In further implementations, the DU 174 sends 416 the UL data to the CU-UP 172B separately via a user-plane (UP) connection as described below. In some such implementations, the UL data includes or is a PDCP PDU, and the PDCP PDU includes an SDAP PDU, an IP packet, or an Ethernet packet.

After receiving 406 the first DU-to-CU message, the CU-CP 172A, in some implementations, sends 408 a UE Context Setup Request message to the DU 174 to establish a UE Context of the UE 102 at the DU 174. In some implementations, the CU-CP 172A includes transport layer information for one or more GTP-U tunnels between the CU-UP 172B and DU 174 in the UE Context Setup Request message so that the DU 174 can transmit the UL data and/or subsequent UL data (e.g., in small data communication 418) via the one or more GTP-U tunnels to the CU-UP 172B. In response, the DU 174 sends 410 a UE Context Setup Response message to the CU-CP 172A. After receiving 406 the first DU-to-CU message, transmitting 408 the UE Context Setup Request message, or receiving 410 the UE Context Setup Response message, the CU-CP 172A transmits 412 a Bearer Context Modification Request message to resume data transmission for the UE 102 to the CU-UP 172B. In response, the CU-UP 172B resumes data transmission for the UE 102 and transmits 414 a Bearer Context Modification Response message to the CU-CP 172A. In some cases where the UL data of the event 404 includes an RRC message or is associated with an SRB (e.g., SRB1 or SRB2), after receiving 408 the UE Context Setup Request message or transmitting 410 the UE Context Setup Response message, the DU 174 transmits 415 the DU-to-CU message including the UL data to the CU-CP 172A. In some cases where the UL data is associated with a DRB, the DU 174 transmits 416 the UL data to the CU-UP 172B. In some cases where the CU-CP 172A determines that the DU 174 already has a UE context of the UE 102, the CU-CP 172A omits the events 408 and 410. For example, the CU-CP 172A commands the DU 174 to retain the UE context of the UE 102 in the case for CG-SDT as described above. In some such cases, the CU-CP 172A transmits a UE Context Modification Request message to the DU 174 to modify the UE context instead of the UE Context Setup Request message, and the DU 174 transmits a UE Context Modification Response message in response.

In some implementations, the CU-CP 172A can include transport layer information for the CU-UP 172B in the UE Context Setup Request message. The transport layer information for the CU-UP 172B can include an IP address and/or an uplink tunnel endpoint ID (e.g., TEID). The DU 174 transmits 416 the UL data to the CU-UP 172B using the transport layer information for the CU-UP 172B. In some cases where the UE 102 has subsequent UL data (e.g., one or more UL data packets) to transmit, the UE 102 transmits 418 one or more subsequent UL MAC PDUs including the subsequent UL data to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages (e.g., UL RRC Message Transfer message(s)) including the subsequent UL data to the CU-CP 172A. Each DU-to-CU message can include a particular UL data packet of the subsequent UL data. In some cases where the CU-CP 172A receives DL data from the CN 110 or edge server, the CU-CP 172A transmits 418 one or more CU-to-DU messages (e.g., DL RRC Message Transfer message(s)) including the DL data (e.g., one or more DL data packets) to the DU 174. In turn, the DU 174 transmits 418 one or more DL MAC PDUs including the DL data to the UE 102 operating in the inactive state. In some implementations, the DL data includes NAS PDU(s) and/or LPP PDU(s).

In cases where the subsequent UL data is associated with one or more DRBs, the DU 174 transmits 418 the subsequent UL data to the CU-UP 172B, similar to the event 416. In some implementations, the DU 174 includes DU transport layer information for the DU 174 in the UE Context Setup Response message. In turn, the CU-CP 172A can include the transport layer information of the DU 174 in the Bearer Context Modification Request message. Depending on the implementation, the transport layer information of the DU 174 includes an IP address and/or a downlink TEID. In some cases where the CU-UP 172B receives DL data from the CN 110 or edge server, the CU-UP 172B transmits 418 the DL data (e.g., one or more DL data packets) to the DU 174 using the transport layer information of the DU 174. In turn, the DU 174 transmits 418 one or more DL MAC PDUs including the DL data to the UE 102 operating in the inactive state.

In some implementations, the UE 102 includes a buffer status report or a power headroom report in the initial and/or subsequent UL MAC PDU(s), in accordance with the BSR configuration and/or PHR configuration, respectively. In the buffer status report, the UE 102 includes or indicates a buffer status for one or more logical channels or logical channel groups. In the power headroom report, the UE 102 includes or indicates a power headroom status or value.

In some example scenarios, the subsequent UL data and/or DL data described above includes Internet Protocol (IP) packet(s), Ethernet packet(s), or application packet(s). In other scenarios, the UL data includes PDU(s) (e.g., RRC PDU(s), PDCP PDU(s), or RLC PDU(s)) that include RRC message(s), NAS message(s), IP packet(s), Ethernet packet(s), or application packet(s).

The events 404, 406, 408, 410, 412, 414, 415 and 416 are collectively referred to in FIG. 4 as a small data transmission procedure 492.

In some implementations, the UL RRC message is an existing RRC resume request message (e.g., an RRCResumeRequest message, an RRCResumeRequest1 message, an RRCConnectionResumeRequest message, or an RRCConnectionResumeRequest1 message). In other implementations, the UL RRC message is a new RRC resume request message, similar to the existing RRC resume request message. For example, the new RRC resume request message may be defined in future 3GPP standards documentation. The new RRC resume request message may be a format similar to an existing RRC resume request message. In the case of the downlink SDT, the UL RRC message includes an SDT indication, which can be a field or information element (IE) (e.g., resumeCause or ResumeCause). In some implementations, the UL RRC message is a common control channel (CCCH) message.

In some implementations, after the UE 102 transmits 404 the UL MAC PDU or communicates 418 the subsequent UL data and/or DL data with the DU 174, the CU-CP 172A determines to stop the SDT for the UE 102 based on data inactivity of the UE 102 (i.e., the UE 102 in the inactive state has no data activity with the base station 104). After the UE 102 transmits 404 the UL MAC PDU or communicates 418 the subsequent UL data and/or DL data with the DU 174, the UE 102 in the inactive state determines or detects data inactivity and transmits 420, to the DU 174, UE assistance information (e.g., a UEAssistanceInformation message) indicating that the UE 102 prefers or requests to stop the SDT.

The events 420 (optional), 421 (optional), 422 (optional), 423, 424, 426, 428, 430, 432 and 434 are collectively referred to in FIG. 4 as an SDT complete procedure 494, similar to the procedure 394. Examples and implementations for events 320, 321, 322, 323, 324, 326, 328, 330, 332, 334 apply to events 420, 421, 422, 423, 424, 426, 428, 430, 432, 434, respectively. Depending on the implementation, after stopping the SDT, the UE 102 performs 493 another small data transmission procedure with the base station 104, similar to the procedure 492. In further implementations, after completing the procedure 493, the UE 102 performs 495 an SDT complete procedure with the base station 104, similar to the procedure 494.

During an SDT session (i.e., events 492 and 494), the UE 102 monitors a PDCCH using a C-RNTI to receive a DCI. In some implementations, the UE 102 receives the C-RNTI in the random access procedure described for the event 404. In other implementations, the UE 102 receives and retains the C-RNTI as described for FIG. 3. In response to or after receiving 434 the RRC release message, the UE 102 ends the SDT session and stops using the C-RNTI to monitor a PDCCH. Depending on the implementation, the UE 102 retains the C-RNTI after receiving 434 the RRC release message or transitioning 436 to the inactive state from the connected state. In some cases where the RRC release message 434 configures CG-SDT, the UE 102 retains the C-RNTI. In further cases where the RRC release message 434 does not configure or releases CG-SDT, the UE 102 releases the C-RNTI.

After the UE 102 ends the SDT session, the UE 102 in the inactive state monitors a PDCCH using a paging RNTI (P-RNTI). In some scenarios or implementations, the CU-CP 172A determines to page the UE 102 to receive a mobile-terminated call or data. In response to the determination, the CU-CP 172A sends a CU-to-DU message (e.g., Paging message) to the DU 174 to request the DU 174 to page the UE 102. In response to the CU-to-DU message, the DU 174 generates a paging message, a DCI to schedule a PDSCH transmission including the paging message, a CRC of the DCI; scrambles the CRC with the P-RNTI to obtain a scrambled C-RNTI; and transmits the DCI and scrambled CRC on a PDCCH that the UE 102 monitors. The UE 102 receives the DCI and the scrambled CRC on the PDCCH and verifies the scrambled CRC with the P-RNTI. In cases where the UE 102 verifies that the scrambled CRC is valid, the UE 102 receives and decodes the PDSCH transmission in accordance with the DCI. The UE 102 subsequently retrieves the paging message from the PDSCH transmission.

In some implementations, the second SDT CU configuration is the same as the first SDT CU configuration. In other implementations, the second SDT CU configuration is different from the first SDT CU configuration. Depending on the implementation, the UE 102 updates (e.g., replace or modify) the first SDT CU configuration with the second SDT CU configuration. In some implementations, the CU-CP 172A includes an indication in the RRC release message to indicate to the UE 102 to update the first SDT CU configuration with the second SDT CU configuration. In some such implementations, the UE 102 updates the first SDT CU configuration with the second SDT CU configuration in response to the indication.

In other implementations, the CU-CP 172A includes a modification indication in the RRC release message to indicate to the UE 102 to modify the first SDT CU configuration with the second SDT CU configuration. In some such implementations, the UE 102 modifies the first SDT CU configuration with the second SDT CU configuration in response to the modification indication. In yet other implementations, the CU-CP 172A includes a setup indication in the RRC release message to indicate to the UE 102 to replace the first SDT CU configuration with the second SDT CU configuration. In some such implementations, the UE 102 replaces the first SDT CU configuration with the second SDT CU configuration in response to the setup indication.

In some implementations, the second SDT DU configuration is the same as the first SDT DU configuration. In other implementations, the second SDT DU configuration is different from the first SDT DU configuration. Depending on the implementation, the UE 102 updates (e.g., replaces or modifies) the first SDT DU configuration with the second SDT DU configuration. In some implementations, the DU 174 includes an indication in the second SDT DU configuration to indicate to the UE 102 to update the first SDT DU configuration with the second SDT DU configuration. In some such implementations, the UE 102 updates the first SDT DU configuration with the second SDT DU configuration in response to the indication.

In other implementations, the DU 174 includes a modification indication in the second SDT DU configuration to indicate to the UE 102 to modify the first SDT DU configuration with the second SDT DU configuration. In some such implementations, the UE 102 modifies the first SDT DU configuration with the second SDT DU configuration in response to the modification indication. In yet other implementations, the DU 174 includes a setup indication in the second SDT DU configuration to indicate to the UE 102 to replace the first SDT DU configuration with the second SDT DU configuration. In some such implementations, the UE 102 replaces the first SDT DU configuration with the second SDT DU configuration in response to the setup indication.

In some cases where the CU-CP 172A and/or the DU 174 support delta configuration, the CU-CP 172A does not send 428 the CU-to-DU message to obtain the second SDT DU configuration from the DU 174. Unless a condition for releasing the first SDT configuration is satisfied, the DU 174 retains the first SDT DU configuration. Alternatively, the CU-CP 172A includes the first SDT DU configuration in the second CU-to-DU message to cause the DU 174 to retain the first SDT DU configuration. In some such cases, the CU-CP 172A does not include an SDT DU configuration and/or an SDT CU configuration in the RRC release message to cause the UE 102 to continue using the first SDT CU configuration and/or the first SDU DU configuration. In some implementations, the CU-CP 172A does not include a release indication in the RRC release message in order to configure the UE 102 to continue using the first SDT DU configuration and/or the first SDT CU configuration. The release indication indicates releasing the previously received SDT DU configuration and/or the SDT CU configuration. In cases where the CU-CP 172A includes the release indication in the RRC release message, the UE 102 releases the first SDT CU configuration and/or the first SDT DU configuration in response to the release indication. In some cases where the CU-CP 172A and/or DU 174 do not support delta configuration, the CU-CP 172A includes the SDT DU configuration and/or the SDT CU configuration in the RRC release message as described above.

In some implementations, in response to the third CU-to-DU message, the DU 174 retains the second SDT DU configuration and can release the first non-SDT DU configuration and/or second non-SDT DU configuration. The DU 174 sends a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the idle state (i.e., RRC_IDLE), the UE 102 releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the SDT DU configuration and SDT CU configuration described for FIG. 3).

In some implementations, the CU-CP 172A does not request the DU 174 to provide an SDT DU configuration for causing the UE 102 to transition to the inactive state with SDT configured. In some such cases, the events 428 and 430 are omitted. In such cases, the CU-CP 172A does not include an SDT DU configuration in the RRC release message. Alternatively, the CU-CP 172A generates the SDT DU configuration alone and includes the SDT DU configuration in the RRC release message.

In some implementations, the DU 174 does not include an SDT DU configuration in the second DU-to-CU message, similarly to the process as described above with regard to FIG. 3. Further, the DU 174 does not include a configuration for CG-SDT in the SDT DU configuration in the second DU-to-CU message, also similarly to the process as described above with regard to FIG. 3.

In some implementations where the UE 102 supports CG-SDT and/or the DU 174 supports CG-SDT, the CU-CP 172A requests the DU 174 to provide an SDT DU configuration, as described above. In cases where the UE 102 does not support CG-SDT or the DU 174 does not support CG-SDT, the CU-CP 172A does not request the DU 174 to provide an SDT DU configuration. Depending on the implementation, the CU-CP 172A receives a UE capability (e.g., UE-EUTRA-Capability IE, UE-NR-Capability IE, or UE-6G-Capability IE) of the UE 102 from the UE 102, the CN 110 (e.g., MME 114 or AMF 164), or the base station 106 before the UE 102 initiates the SDT, while the UE 102 operates 402 in the inactive state, while the UE 102 performs the SDT (e.g., in the UE Context Setup Request message of the event 408 or the CU-to-DU message of the event 428), or while the UE 102 operates in the connected state as described for FIG. 3. The UE capability indicates whether the UE 102 supports CG-SDT. Thus, the CU-CP 172A can determine whether the UE supports CG-SDT in accordance with the UE capability. In some implementations, the CU-CP 172A receives, from the DU 174, a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 determines whether to provide an SDT DU configuration for the UE 102 to the CU-CP 172A, depending on whether the UE 102 or the DU 174 support CG-SDT or not, similarly to FIG. 3 above. Further, the DU 174 can determine and signal whether the UE 102 supports CG-SDT, similarly to FIG. 3 above.

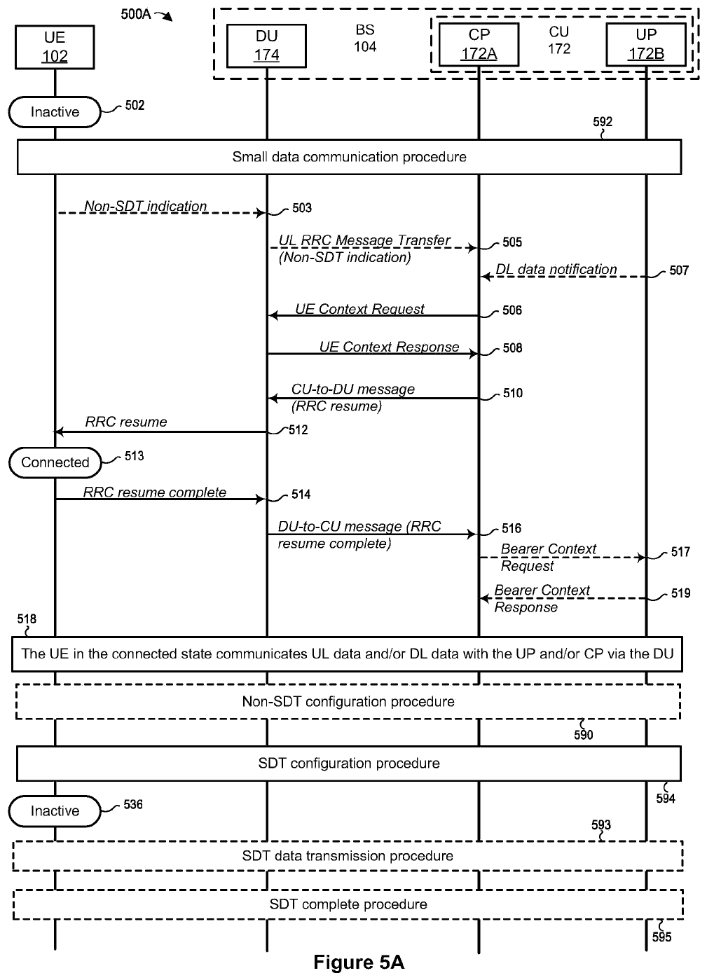

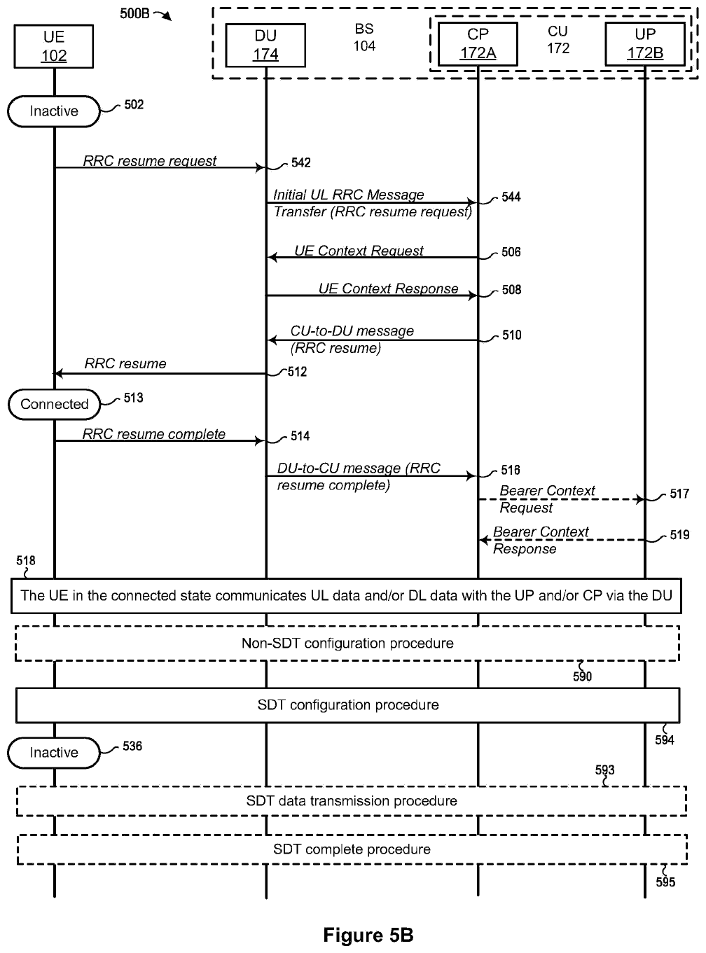

Referring now to FIG. 5A, a scenario 500A depicts small data transmission and transitioning from SDT to non-SDT. In the scenario 500, the base station 104 includes a CU 172 and a DU 174. The CU 172 includes a CU-CP 172A and a CU-UP 172B. In the scenario 500A, the UE 102 initially operates 502 in an inactive state with SDT configured, similar to the event 402 or 436. The UE 102 then performs 592 a small data transmission procedure with the base station 104, similar to the event 492 or 493.

During the small data transmission procedure 592, the CU-CP 172A determines whether to transition the UE 102 to a connected state, e.g., based on UL or DL data activity of the UE 102. In some implementations, the UE 102 transmits 503 a non-SDT indication as a message or within a message to the DU 174 to indicate that non-SDT UL data is available or to request to transition to the connected state. In some implementations, the UE 102 transmits 503 the non-SDT indication to the DU 174 on radio resources configured in a CG configuration for SDT (or CG-SDT configuration). In other implementations, the UE 102 receives a dynamic uplink grant on a PDCCH from the DU 174 using a C-RNTI and transmits 503 the non-SDT indication to the DU 174 on radio resources configured in the dynamic uplink grant. In turn, the DU 174 transmits 505 a UL RRC Message Transfer message including the non-SDT indication to the CU-CP 172A.

In some implementations, the CU-CP 172A determines to cause the UE 102 to transition to the connected state in response to or based on the non-SDT indication. In other implementations, the CU-UP 172B receives DL data from the CN 110 and transmits 507 a DL data notification (e.g., DL Data Notification message) to the CU-CP 172A to indicate that DL data is available for transmission in response to receiving the DL data. In further implementations, the CU-CP 172A determines to cause the UE 102 to transition to the connected state in response to or based on the DL data notification. In yet other implementations, the CU-CP 172A determines to cause the UE 102 to transition to the connected state based on measurement results received from the UE 102. In other implementations, the CU-CP 172A receives DL data (e.g., NAS message(s)) from the CN 110 and determines to cause the UE 102 to transition to the connected state in response to receiving the DL data.

In some implementations, the UL data and DL data is/are associated with radio bearer(s) (e.g., SRB(s) and/or DRB(s)). For example, the UL data includes RRC message(s) or NAS message(s) associated with SRB(s). In another example, the UL data includes IP packet(s) associated with DRB(s). In some implementations, the UE 102 can include ID(s) of the radio bearer(s) in the message with the non-SDT indication. Thus, the CU-CP 172A can determine whether to cause the UE 102 to transition to the connected state based on the ID(s). For example, if the radio bearer(s) the ID(s) identify do not qualify for SDT, the CU-CP 172A determines to cause the UE 102 to transition to the connected state. Otherwise, the CU-CP 172A determines not to cause the UE 102 to transition to the connected state.

In some implementations, the UE 102 includes data volume information for the UL data in the message including the non-SDT indication. Thus, the CU-CP 172A can determine whether to cause the UE 102 to transition to the connected state based on the data volume information. In some implementations, the data volume information includes a total data volume of the UL data, which the UE 102 can quantize or round to a value for the data volume information. In another implementation, the data volume information includes a data volume for each of the radio bearer(s), which the UE 102 can quantize or round to a value for the data volume information. For example, if the total data volume is above a predetermined threshold, the CU-CP 172A determines to cause the UE 102 to transition to the connected state. Otherwise, the CU-CP 172A can determine not to cause the UE 102 to transition to the connected state. In another example, if the data volume for a particular radio bearer is above a predetermined threshold, the CU-CP 172A determines to cause the UE 102 to transition to the connected state. Otherwise, the CU-CP 172A determines not to cause the UE 102 to transition to the connected state. In yet another example, if the total data volume is above a predetermined threshold and the data volume for a particular radio bearer is above another predetermined threshold, the CU-CP 172A determines to cause the UE 102 to transition to the connected state. Otherwise, the CU-CP 172A determines not to cause the UE 102 to transition to the connected state.

Generally, each of events 506, 508, 510, and 512 are similar to events 306, 308, 310, and 312 of FIG. 3, respectively, except occurring while the UE 102 is in an inactive state and as otherwise outlined below. In response to or after determining to cause the UE 102 to transition to the connected state, the CU-CP 172A transmits 506 a UE Context Request message (e.g., a UE Context Setup Request message or a UE Context Modification Request message) to the DU 174. In response, the DU 174 transmits 508 a UE Context Response message (e.g., a UE Context Setup Response message or a UE Context Modification Response message) to the CU-CP 172A. In some implementations, the DU 174 includes a non-SDT DU configuration (i.e., a first non-SDT DU configuration) in the UE Context Response message. After receiving the UE Context Response message, the CU-CP 172A transmits 510 a CU-to-DU message including an RRC resume message (e.g., an RRCResume message or an RRCConnectionResume message) to the DU 174. In turn, the DU 174 transmits 512 the RRC resume message to the UE 102.

In some implementations, the DU 174 transmits 512 one or more PDUs including the RRC resume message to the UE 102. The PDU(s) can be MAC PDU(s) or RLC PDU(s). In some implementations, the CU-to-DU message is a DL RRC Message Transfer message or a UE Context Modification Request message. In some cases where the message is the UE Context Modification Request message, the DU 174 transmits a UE Context Modification Response message to the CU-CP 172A in response. In response to the RRC resume message, the UE 102 transitions 513 to the connected state and transmits 514 an RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 516 a DU-to-CU message including the RRC resume complete message to the CU-CP 172A.

After determining to cause the UE 102 to transition to the connected state, the CU-CP 172A transmits a 517 Bearer Context Request message (e.g., a Bearer Context Setup Request message or a Bearer Context Modification Request message) to the CU-UP 172B to indicate to the CU-UP 172B to resume all suspended radio bearer(s) of the UE 102. In response, the CU-UP 172B resumes all suspended radio bearer(s) for the UE 102 and transmits 519 a Bearer Context Response message (e.g., a Bearer Context Setup Response message or a Bearer Context Modification Response message) to the CU CP-172A. In some implementations, the CU-CP 172A transmits 517 the Bearer Context Request message after transmitting 506 the UE Context Request message, receiving 508 the UE Context Response message, transmitting 510 the CU-to-DU message, or receiving 516 the DU-to-CU message. In cases where the CU-CP 172A determines that no radio bearers of the UE 102 are suspended when determining to cause the UE 102 to transition to the connected state, the CU-CP 172A does not transmit the Bearer Context Request message 517 to the CU-UP 172B.

In some implementations, the CU-CP 172A includes an indication in the UE Context Request message at event 506 indicating to the DU 174 to generate a non-SDT configuration, and the DU 174 includes the first non-SDT DU configuration in the UE Context Response message at event 508 in response to the indication. In other implementations, the CU-CP 172A stores a non-SDT DU configuration (i.e., a second non-SDT DU configuration) that a DU (e.g., the DU 174 or another DU or base station) used to communicate with the UE 102. The UE 102 can also store the second non-SDT DU configuration. In such cases, the CU-CP 172A includes the second non-SDT DU configuration in the UE Context Request message, and the DU 174 includes the first non-SDT DU configuration in the UE Context Response message in response to receiving the second non-SDT DU configuration. In some implementations, the first non-SDT DU configuration augments or replaces the second non-SDT DU configuration. Examples and implementations for the first and second non-SDT DU configurations are similar to the non-SDT DU configurations described above. In some implementations, the DU 174 transmits an additional DU-to-CU message (e.g., a UE Context Modification Required message) including the first non-SDT DU configuration to the CU-CP 172A instead of including the first non-SDT DU configuration in the UE Context Response message.

After transitioning to the connected state, the UE 102 communicates 518 UL data and/or DL data with the CU-CP 172A and/or CU-UP 172B via the DU 174 using the non-SDT configuration. Depending on the implementation, the UL data includes the UL data triggering the UE to transmit the non-SDT indication and/or new UL data available for transmission. In further implementations, the DL data includes the DL data received from the CN 110 as described above and/or new DL data received from the CN 110. In cases where the RRC resume message includes the first non-SDT DU configuration, the UE 102 communicates 518 with the DU 174 using the first non-SDT DU configuration. In some cases where the first non-SDT DU configuration does not completely replace the second non-SDT DU (i.e., the UE 102 does not release the second non-SDT DU configuration in response to the RRC resume message), the UE 102 communicates 518 with the DU 174 using the configuration parameters in the second non-SDT DU configuration, which the first non-SDT DU configuration does not augment.

In some implementations, the DU 174 does not provide the first non-SDT DU configuration to the CU-CP 172A in the UE Context Response message and the additional DU-to-CU message. In such cases, the RRC resume message does not include the first non-SDT configuration, and the UE 102 and the DU 174 communicate 518 with one another using the second non-SDT DU configuration.

In some implementations, the UE 102 releases the SDT configuration(s) (e.g., the SDT CU configuration, the SDT DU configuration, and/or the CG-SDT configuration(s)) in response to the RRC resume message or to transitioning to the connected state. In some implementations, the base station 104 (e.g., the CU-CP 172A and/or DU 174) releases the SDT configuration(s) in response to or after causing the UE 102 to transition to the connected state, receiving 510 the CU-to-DU message, or transmitting 510, 512 the RRC resume message. In other implementations, the base station 104 releases the SDT configuration(s) in response to or after receiving an acknowledgement (e.g., a RLC acknowledgement or a HARQ acknowledgement) for the PDU(s) including the RRC resume message. In yet other implementations, the base station 104 (e.g., the CU-CP 172A and/or DU 174) releases the SDT configuration(s) in response to or after communicating 506 the UE Context Request message or 508 the UE Context Response message.

In other implementations, the UE 102 retains the SDT configuration(s) (e.g., the SDT CU configuration, the SDT DU configuration and/or the CG-SDT configuration(s)) in response to receiving the RRC resume message or transitioning to the connected state. In some implementations, the UE 102 refrains from using the SDT configuration(s) to communicate (e.g., 514 the RRC resume complete message and/or 518 data) with the base station 104 while operating in the connected state. In other implementations, the UE 102 uses the SDT configuration(s) to communicate (e.g., 514 the RRC resume complete message and/or 518 data) with the base station 104 while operating in the connected state.

In some implementations, the base station 104 retains the SDT configuration(s) in response to or after causing the UE 102 to transition to the connected state or transmitting the RRC resume message. In some implementations, the base station 104 refrains from using the SDT configuration(s) to communicate (e.g., 514 the RRC resume complete message and/or 518 data) with the UE 102 operating in the connected state. In other implementations, the base station 104 uses the SDT configuration(s) to communicate (e.g., 514 the RRC resume complete message and/or 518 data) with the UE 102 operating in the connected state.

In some implementations, the non-SDT indication is in an RRC message (e.g., a UEAssistanceInformation message or a new RRC message). In some such implementations, the UE 102 continues to perform 518 data communication with the base station 104 after transmitting the non-SDT indication. In some implementations, the UE 102 transmits a UL MAC PDU including the non-SDT indication to the CU-CP 172A via the DU 174. In some implementations, the UE 102 includes data in the UL MAC PDU in addition to the non-SDT indication. In other implementations, the UE refrains from including data in the UL MAC PDU. In some implementations, the UE 102 transmits the non-SDT indication to the CU-CP 172A via the DU 174 and SRB1. In such implementations, the UE 102 refrains from re-establishing a UE PDCP entity for the SRB1 in response to determining to transmit the non-SDT indication. The UE 102 generates a UL PDCP PDU including the non-SDT indication using the UE PDCP entity and transmits 503, 505 the UL PDCP PDU to the CU-CP 172A via the DU 174. Then, the UE 102 uses the UE PDCP entity to receive 512 a DL PDCP PDU including the RRC resume message without re-establishing the UE PDCP entity. The CU-CP 172A uses a CU-CP PDCP entity to receive the 505 the UL PDCP PDU. The CU-CP 172A refrains from re-establishing the CU-CP PDCP entity for the SRB1 in response to receiving the non-SDT indication. The CU-CP 172A generates the DL PDCP PDU using the CU-CP PDCP entity and transmits 510, 512 the DL PDCP PDU to the UE 102 via the DU 174 and SRB1. The UE 102 generates a UL PDCP PDU including the RRC resume complete message using the UE PDCP entity and transmits 514, 516 the UL PDCP PDU to the CU-CP 172A via the DU 174 and SRB1. The CU-CP 172A receives 514, 516 the UL PDCP PDU from the UE 102 via the DU 174, using the CU-CP PDCP entity. In such implementations, the UE 102 and the CU-CP 172A communicate the PDCP PDUs via the SRB1 without re-establishing the UE PDCP entity and CU-CP PDCP entity.

In other implementations, the non-SDT indication is in an RRC resume request message (e.g., RRCResumeRequest message or RRCResumeConnectionRequest message). In some such implementations, the UE 102 stops 518 data communication with the base station 104 to transmit the non-SDT indication. In some implementations, the UE 102 transmits the non-SDT indication to the CU-CP 172A via the DU 174 and SRB0. In some implementations, the UE 102 re-establishes the UE PDCP entity in response to determining to transmit the non-SDT indication. After re-establishing the UE PDCP entity, the UE 102 receives 512 the DL PDCP PDU using the UE PDCP entity. Similarly, the CU-CP 172A re-establishes the CU-CP PDCP entity upon receiving the non-SDT indication. After re-establishing the CU-CP PDCP entity, the CU-CP 172A generates the DL PDCP PDU using the CU-CP PDCP entity and transmits 510, 512 the DL PDCP PDU to the UE 102 via the DU 174 and SRB1. After re-establishing the UE PDCP entity, the UE 102 generates a UL PDCP PDU including the RRC resume complete message using the UE PDCP entity and transmits 514, 516 the UL PDCP PDU to the CU-CP 172A via the DU 174 and SRB1. After re-establishing the CU-CP PDCP entity, the CU-CP 172A receives 514, 516 the UL PDCP PDU from the UE 102 via the DU 174, using the CU-CP PDCP entity.

Before performing 592 the small data transmission procedure, the UE 102 operating 502 in the inactive state starts or restarts a first UE CG-SDT timer (e.g., CG-SDT-TAT), as described for FIGS. 3 and 4. In some implementations, the UE 102 starts or restarts the first UE CG-SDT timer in response to receiving a timing advance command from the DU 174 during 592 the small data transmission procedure. In some implementations, the UE 102 maintains (e.g., keeps running or does not stop, start, or restart) the first UE CG-SDT timer (e.g., CG-SDT-TAT) in response to or after receiving 512 the RRC resume message. In other implementations, the UE 102 stops the first UE CG-SDT timer in response to or after receiving 512 the RRC resume message.

Similarly, in some implementations, the DU 174 runs a first DU CG-SDT timer for the UE 102 operating 502 in the inactive state, as described for FIGS. 3 and 4. In some implementations, the DU 174 starts or restarts the first DU CG-SDT timer in response to transmitting (not shown) a timing advance command to the UE 102. In some implementations, the DU 174 maintains (e.g., keeps running or does not stop, start or restart) the first DU CG-SDT timer in response to or after receiving 506 the UE Context Request message, transmitting 508 the UE Context Response message, or transmitting 512 the RRC resume message. In other implementations, the DU 174 stops the first DU CG-SDT timer in response to or after receiving 506 the UE Context Request message, transmitting 508 the UE Context Response message, or transmitting 512 the RRC resume message. In some cases where the first DU CG-SDT timer expires, the DU 174 releases the CG-SDT configuration(s). In other cases where the first DU CG-SDT timer expires, the DU 174 retains the CG-SDT configuration(s) and refrains from receiving or attempting to receive UL transmissions (e.g., MAC PDUs) on the CG resources. In some such cases, the DU 174 releases the CG resources or determines the CG resources as not valid.

In some implementations, the UE 102 in the inactive state runs a second UE CG-SDT timer during 592 the small data transmission procedure, as described for the procedure 492. In some implementations where the second UE CG-SDT timer is running, the UE 102 stops the second UE CG-SDT timer in response to or after receiving 512 the RRC resume message or transitioning 513 to the connected state. In other implementations, the UE 102 maintains the second UE CG-SDT timer running in response to or after receiving 512 the RRC resume message or transitioning 513 to the connected state. In some implementations, the UE 102 receives an RRC setup message (e.g., RRCSetup message) instead of the RRC resume message. In response to or after receiving the RRC setup message, the UE 102 stops the second UE CG-SDT timer and transmits an RRC setup complete message to the CU-CP 172A via the DU 174.

Similarly, depending on the implementation, the DU 174 runs a second DU CG-SDT timer during 592 the small data transmission procedure. In some implementations, the DU 174 starts or restarts the second DU CG-SDT timer when or after receiving from the UE 102 a PUSCH transmission on radio resources configured in the CG-SDT configuration. In further implementations, while the second DU CG-SDT timer runs, the DU 174 transmits a PDCCH using the C-RNTI. In cases where the second DU CG-SDT timer is running, the DU 174 stops the second DU CG-SDT timer in response to or after receiving 506 the UE Context Request message, transmitting 508 the UE Context Response message, or transmitting 512 the RRC resume message. In other implementations, the DU 174 maintains the second DU CG-SDT timer in response to or after receiving 506 the UE Context Request message, transmitting 508 the UE Context Response message, or transmitting 512 the RRC resume message. The DU 174 transmits, to the UE 102 operating in the connected state, (a DCI on) a PDCCH using the C-RNTI irrespective of the second DU CG-SDT timer (e.g., running, expiring or stopping).

In some implementations, later in time, the base station 104 performs 590 a non-SDT resource (re) configuration procedure and performs 594 an SDT configuration procedure with the UE 102, similar to the procedure 390 and the procedure 394, respectively. The UE 102 transitions 536 to the inactive state in response to receiving an RRC release message in the procedure 594. Depending on the implementation, after transitioning to the inactive state, the UE 102 in the inactive state performs 593 a small data transmission procedure and/or 595 an SDT complete procedure with the base station 104, similar to the procedure 492 and 494, respectively.

Referring next to FIG. 5B, a scenario 500B is generally similar to the scenario 500A, except that the UE 102 initiates an RRC resume procedure instead of performing 592 the small data transmission procedure. The differences between the scenarios 500B and 500A are discussed below.

In response to initiating the RRC resume procedure, the UE 102 in the inactive state transmits 542 an RRC resume request message to the DU 174, which in turn transmits 544 an Initial UL RRC Message Transfer message including the RRC resume request message (e.g., an RRCResumeRequest message or an RRCConnectionResumeRequest message) to the CU-CP 172A. In response to receiving the RRC resume request message, the CU-CP 172A determines to transition the UE 102 to the connected state. In response to or after determining to cause the UE 102 to transition to the connected state, the CU-CP 172A causes the UE 102 to transition to the connected state as described for the scenario 500A.

In some implementations, the UE 102 generates a UL MAC PDU including the RRC resume request message and transmits 542 UL MAC PDU to the DU 174. In further implementations, the UE 102 transmits 542 to the DU 174 the UL MAC PDU on radio resources configured in a CG configuration for SDT. In other implementations, the UE 102 performs a random access procedure to transmit the UL MAC PDU, similar to the event 404.

In some implementations, the UE 102 initiates the RRC resume procedure to transmit non-SDT data (i.e., data not qualifying for SDT). More specifically, an upper protocol layer (e.g., NAS layer) of the UE 102 requests an RRC layer (e.g., RRC 214) of the UE 102 to initiate the RRC resume procedure. In other implementations, the UE 102 receives a paging message from the DU 174 and initiates the RRC resume procedure to respond the paging message. In some implementations, the RRC layer (e.g., RRC 214) initiates the RRC resume procedure in response to the paging message. In yet other implementations, the UE 102 detects when a periodic RAN notification area update (RNAU) timer expires and initiates the RRC resume procedure in response to the periodic RNAU timer expiring. In some implementations, the RRC layer (e.g., RRC 214) starts or restarts the RNAU timer, maintains the RNAU timer, and initiates the RRC resume procedure in response to the RNAU timer expiring.

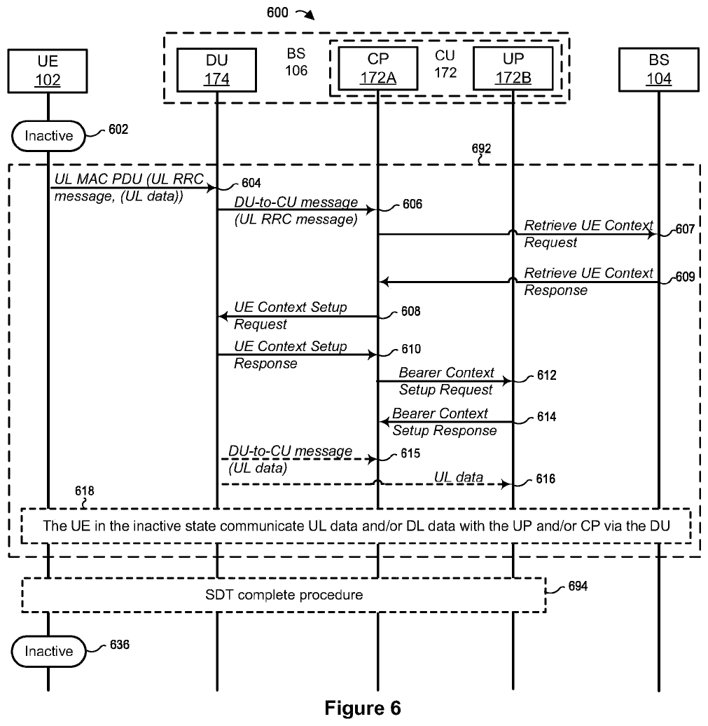

Referring next to FIG. 6, a scenario 600 depicts small data transmission, similar to the scenario 400. Except events 607 and 609, events 602, 604, 606, 608, 610, 612, 614, 615, 616, 618, 694, 636 are similar to events 402, 404, 406, 408, 410, 412, 414, 415, 416, 418, 494, 436. Examples and implementations for FIG. 4 can apply to FIG. 6. The differences between FIG. 4 and FIG. 6 are described below.

In the scenario 600, the UE 102 initially operates 602 in an inactive state with an SDT configuration configured by the base station 104, as described for FIG. 3 or FIG. 4. In some implementations, the SDU configuration include CG-SDT configuration(s). In some such cases, the UE 102 discards the CG-SDT configuration(s) because the base station 106 does not configure the CG-SDT configuration(s) for the UE 102, i.e., the CG-SDT configuration(s) is not valid.

In response to or after receiving 606 the UL RRC message, the CU-CP 172A transmits 607 a Retrieve UE Context Request message to the base station 104. In response, the base station 104 transmits 609 a Retrieve UE Context Response message to the CU-CP 172A. After receiving the Retrieve UE Context Response message, the CU-CP 172A transmits 608 a UE Context Setup Request message to the DU 174, receives 610 a UE Context Setup Response message from the DU 174, and transmits 612 an RRC resume message to the DU 174. The CU-CP 172A transmits 612 a Bearer Context Setup Request message to the CU-UP 172B to request the CU-UP 172B to set up bearer context(s) for SDT DRB(s) configured in the SDT configuration. In response, the CU-UP 172B sets up bearer context(s) for the SDT DRB(s) and transmits 614 a Bearer Context Setup Response message to the CU-CP 172A to confirm that that bearer context(s) for the SDT DRB(s) has been set up.

In some implementations, the base station 104 includes the SDT configuration in the Retrieve UE Context Response message. In some cases where the SDT configuration includes CG-SDT configuration(s), the base station 104 excludes the CG-SDT configuration(s) from the SDT configuration. Alternatively, the CU-CP 172A still includes the CG-SDT configuration(s) from the SDT configuration. In some implementations, when the CU-CP 172A receives the CG-SDT configuration(s), the CU-CP 172A discards the CG-SDT configuration(s). In further implementations, the CU-CP 172A discards the SDT configuration, such as in cases where the CU-CP 172A does not support delta configuration. In some cases where the CU-CP 172A supports delta configuration, the CU-CP 172A takes the SDT configuration (e.g., a first SDT configuration) into account when the CU-CP 172A determines to transition the UE to the inactive state at the SDT complete procedure 694, similar to the procedure 494. In other implementations, the CU-CP 172A refrains from including the SDT configuration in the Retrieve UE Context Request message.

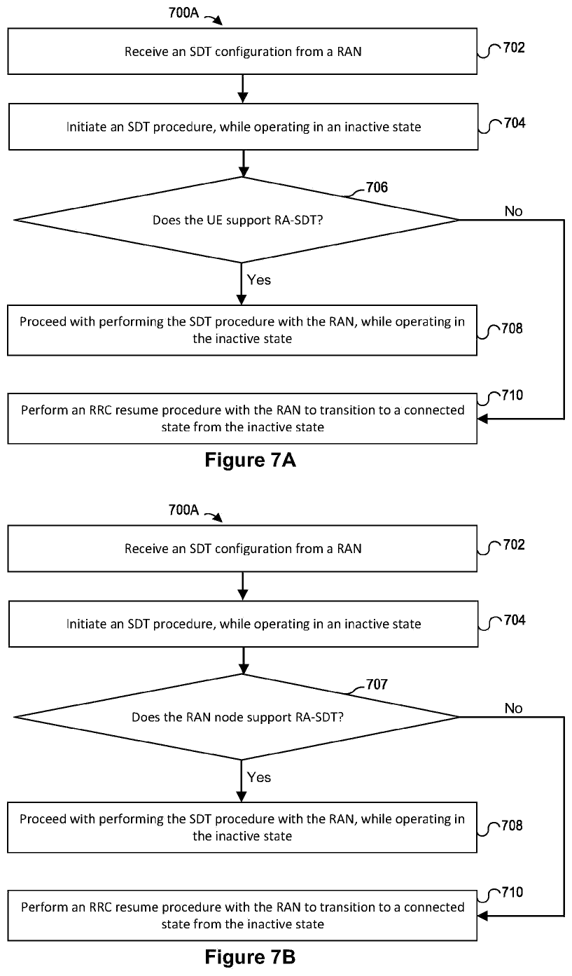

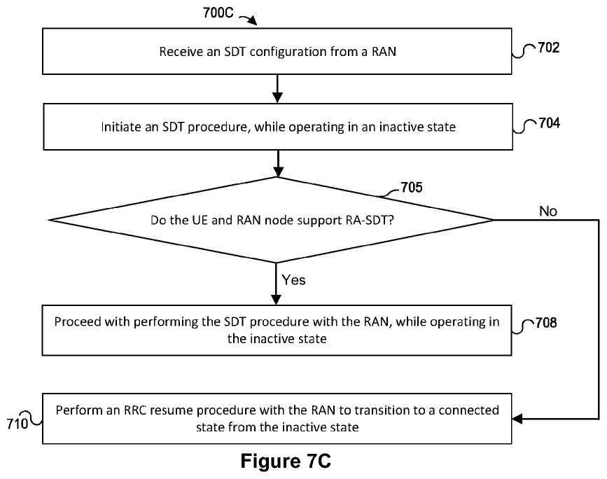

Next, several example methods that can be implemented in a UE, a base station, a DU of a base station, or a CU of a base station are discussed with reference to FIGS. 7A-15. Each of these methods can be implemented using processing hardware such as one or more processors to execute instructions stored on a non-transitory computer-readable medium such as computer memory. For clarity, the methods of FIGS. 7A to 15 are discussed with specific reference to UE 102, base station 104, RAN 105, CU 172, and DU 174.

Referring first to FIG. 7A, a method 700A can be implemented in a suitable UE and includes determining whether to proceed with an SDT procedure based on whether the UE supports RA-SDT communication.

At block 702, the UE 102 receives an SDT configuration from a node of a RAN 105, such as base station 104 (334/394, 402/434/494, 502/594, and 602/694 of FIGS. 3-6). At block 704, the UE 102 initiates an SDT procedure, while operating in an inactive state (e.g., events 492/493/494, 592/593/595, and 692/694 of FIGS. 4-6). In some implementations, the UE 102 initiates or determines to initiate the SDT procedure, if the UE 102 determines one or more conditions for initiating the SDT procedure are met. In some implementations, the condition(s) include: 1) a system information block 1 (SIB1) of a cell currently camped by the UE 102 includes an SDT configuration (e.g., sdt-ConfigCommon); 2) all the pending data for transmission are only associated to radio bearer(s) for SDT; 3) data volume of all the pending data is lower than or equal to a threshold (e.g., sdt-DataVolumeThreshold); and/or 4) signal strength (e.g., RSRP) of a downlink pathloss reference is higher than a threshold (e.g., sdt-RSRP-Threshold).

At block 706, the flow branches depending on whether the UE 102 supports RA-SDT communication. In implementations in which the UE 102 supports RA-SDT communication, the flow continues to block 708. Otherwise, the flow continues to block 710. At block 708, the UE 102 proceeds with the SDT procedure with the RAN 105, while continuing to operate in the inactive state (e.g., events 493 and 593 of FIGS. 4-5B).

Further, in some implementations in which the UE 102 supports RA-SDT communication, the UE 102 transmits an RA-SDT support indication indicating support for RA-SDT communication to the RAN 105. In some implementations in which the UE 102 does not support RA-SDT communication, the UE 102 refrains from transmitting an RA-SDT support indication to the RAN 105. In another example, the UE 102 transmits, to a CN 110 via the RAN 105, the message including a capability ID identifying a number of UE capabilities for the UE 102. Depending on the implementation, the number of UE capabilities includes the RA-SDT capability. In some such implementations, the RAN 105 receives the UE capabilities from the CN 110. In some implementations, the UE 102 can be preconfigured to support RA-SDT communication. For example, the UE 102 can store a first flag in a non-volatile memory. In cases where the first flag is set to a first value, the UE 102 enables or supports RA-SDT communication. In cases where the first flag is set to a second value, the UE disables or does not support RA-SDT communication.

At block 710, the UE 102 performs an RRC resume procedure with the RAN 105 to transition to a connected state from the inactive state (e.g., events 495 and 595 of FIGS. 4-5B). In some implementations, at block 710, the UE 102 stops performing the SDT procedure entirely.

In some implementations, the UE 102 supports CG-SDT communication. In some such implementations, the UE 102 transmits a CG-SDT support indication indicating support for CG-SDT communication to the RAN 105 or the CN 110 via the RAN 105. In some implementations in which the UE 102 does not support CG-SDT communication, the UE 102 refrains from transmitting the CG-SDT support indication to the RAN 105 or the CN 110. In further implementations, the UE 102 is preconfigured to support CG-SDT communication. For example, the UE 102 stores a first flag in a non-volatile memory. In cases where the second flag is set to a third value, the UE 102 enables or supports CG-SDT communication. In cases where the second flag is set to a fourth value, the UE 102 disables or does not support CG-SDT communication. In some implementations, the first flag and second flag can be the same flag. In other implementations, the first flag and second flag can be different flags.

Referring next to FIG. 7B, a method 700B can be implemented in a suitable UE and includes determining whether to proceed with an SDT procedure based on whether a RAN supports RA-SDT communication. FIG. 7B is very similar to FIG. 7A. FIG. 7B differs from FIG. 7A in that the decision block 707 focuses on whether the RAN, rather than the UE, supports RA-SDT.

In some implementations, if the SDT configuration (e.g., SDT-Config) includes an RA-SDT configuration, the UE 102 determines that the RAN 105 supports RA-SDT communication. Otherwise, in such implementations, if the SDT configuration does not include an RA-SDT configuration, the UE 102 determines that the RAN 105 does not support RA-SDT communication. In some implementations, the RA-SDT configuration is an RA-SDT indication or an RA-SDT enabled indication. In other implementations, the RA-SDT configuration is a random access configuration or a timer value for RA-SDT, such as a logicalChannelSR-DelayTimer. In other implementations, the UE 102 receives the SDT configuration camps on a cell of the RAN 105 and determines whether the cell or RAN 105 supports RA-SDT communication based on an SIB (e.g., SIB1) received by the UE 102 on the cell. The RAN 105 broadcasts the SIB on the cell. For example, if the SIB includes an SDT configuration (e.g. sdt-ConfigCommon, SDT-ConfigCommonSIB, or SDT-ConfigCommonSIB-r17), the UE 102 determines that the RAN 105 or the cell supports RA-SDT communication. If the SIB does not include the SDT configuration, the UE 102 determines that the cell does not support RA-SDT communication. In another example, if the SIB or the SDT configuration in the SIB includes an RA-SDT configuration, the UE 102 determines that the RAN 105 or the cell supports RA-SDT communication. If the SIB or SDT configuration does not include an RA-SDT configuration, the UE 102 determines that the RAN 105 or the cell does not support RA-SDT communication. In some implementations, the RA-SDT configuration is an RA-SDT indication or an RA-SDT enabled indication. In other implementations, the RA-SDT configuration is a random access configuration or a timer value for RA-SDT, such as a logicalChannelSR-DelayTimer. In yet other implementations, the RA-SDT configuration is a signal strength or quality threshold configuration (e.g., sdt-RSRP-Threshold, sdt-RSRP-Threshold-r17, or RSRP-Range) for the UE 102 to determine whether to initiate an RA_SDT procedure. For example, the UE 102 obtains a signal strength or quality of a downlink pathloss reference. Depending on the implementation, if the signal strength or quality is higher than a threshold value in the threshold configuration, the UE 102 initiates an RA-SDT procedure. Otherwise, the UE 102 refrains from initiating an RA-SDT procedure.

Referring next to FIG. 7C, a method 700C can be implemented in a suitable UE and includes determining whether to proceed with an SDT procedure based on whether both the UE and a RAN support RA-SDT communication. FIG. 7C fuses block 706 from FIG. 7A and block 707 from FIG. 7B as well as all the related description.

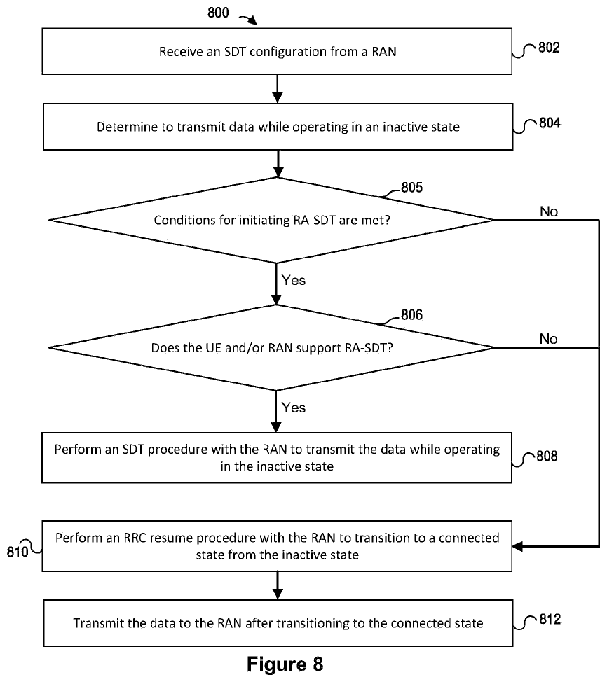

Referring next to FIG. 8, a method 800 can be implemented in a suitable UE and includes whether to perform an SDT procedure based on whether the UE and/or a RAN support RA-SDT communication and whether the conditions for initiating RA-SDT are met.

Blocks 802 and 804 are similar to blocks 702 and 704, as described with regard to FIG. 7A. At block 805, the UE 102 determines whether conditions for initiating RA-SDT are met. In implementations in which the conditions are met, flow continues to block 806. Otherwise, flow continues to block 810. At block 806, the UE 102 determines whether either of the UE 102 or RAN 105 support RA-SDT communication. In implementations in which either supports RA-SDT communication, the flow continues to block 808. Otherwise, flow continues to block 810. At block 808, the UE 102 performs an SDT procedure with the RAN 105 to transmit the data while operating in an inactive state (e.g., events 493 and 593 of FIGS. 4-5B). At block 810, the UE 102 performs an RRC resume procedure with the RAN 105 to transition to a connected state from the inactive state (e.g., events 495 and 595 of FIGS. 4-5B). In some implementations, at block 810, the UE 102 refrains from performing an SDT procedure to transmit the data. At block 812, the UE 102 transmits the data to the RAN 105 after transitioning to the connected state (e.g., events 495 and 595 of FIGS. 4-5B).

Examples and implementations described for FIG. 7A-7C can apply to FIG. 8.

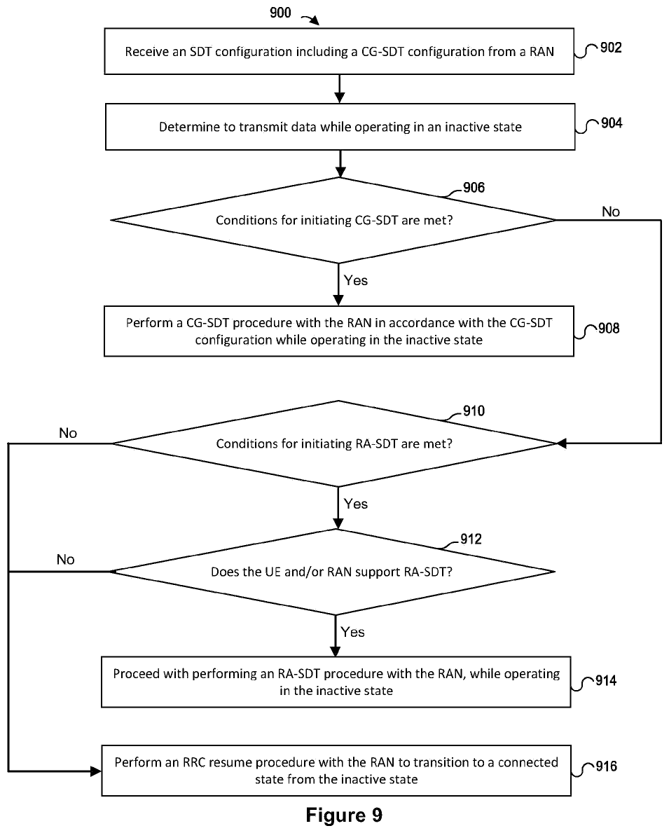

Referring next to FIG. 9, a method 900 can be implemented in a suitable UE and includes determining whether to perform a CG-SDT procedure, an RA-SDT procedure, or an RRC resume procedure based on whether conditions for initiating CG-SDT or RA-SDT are met.

At block 902, the UE 102 receives an SDT configuration including a CG-SDT configuration from a node of a RAN 105, such as base station 104 (334/394, 402/434/494, 502/594, and 602/694 of FIGS. 3-6). At block 904, the UE 102 determines to transmit data while operating in an inactive state (e.g., events 492/493/494, 592/593/595, and 692/694 of FIGS. 4-6). At block 906, the UE 102 determines whether conditions for initiating CG-SDT are met. In implementations in which the conditions are met, the flow continues to block 908. Otherwise, flow continues to block 910. At block 908, the UE 102 performs a CG-SDT procedure with the RAN 105 in accordance with the CG-SDT configuration while operating in the inactive state (e.g., events 493 and 593 of FIGS. 4-5B). At block 910, the UE 102 determines whether conditions for initiating RA-SDT are met instead. In implementations in which the conditions are met, flow continues to block 912. Otherwise, flow proceeds to block 916. At block 912, the UE 102 further determines whether either the UE 102 or RAN 105 supports RA-SDT communication. In implementations in which either supports RA-SDT communication, flow continues to block 914. Otherwise, the flow proceeds to block 916. At block 914, the UE 102 proceeds with performing an RA-SDT procedure with the RAN 105 while operating in the inactive state (e.g., events 493 and 593 of FIGS. 4-5B). At block 916, the UE 102 performs an RRC resume procedure with the RAN 105 to transition to a connected state from the inactive state (e.g., events 495 and 595 of FIGS. 4-5B).

In some implementations, the conditions for initiating CG-SDT include: the condition(s) 1), 2), 3), and/or 4) described for FIG. 7A, and/or 5) at least one SSB configured for CG-SDT with Synchronization Signal reference signal received power (SS-RSRP) above a CG-SDT RSRP threshold (e.g., cg-SDT-RSRP-ThresholdSSB) is available. In some implementations, the CG-SDT configuration includes the CG-SDT RSRP threshold. In some implementations, the conditions for initiating RA-SDT include: the condition(s) 1), 2), 3), and/or 4) described for FIG. 7A.

Examples and implementations described in the previous figures can apply to FIG. 9.

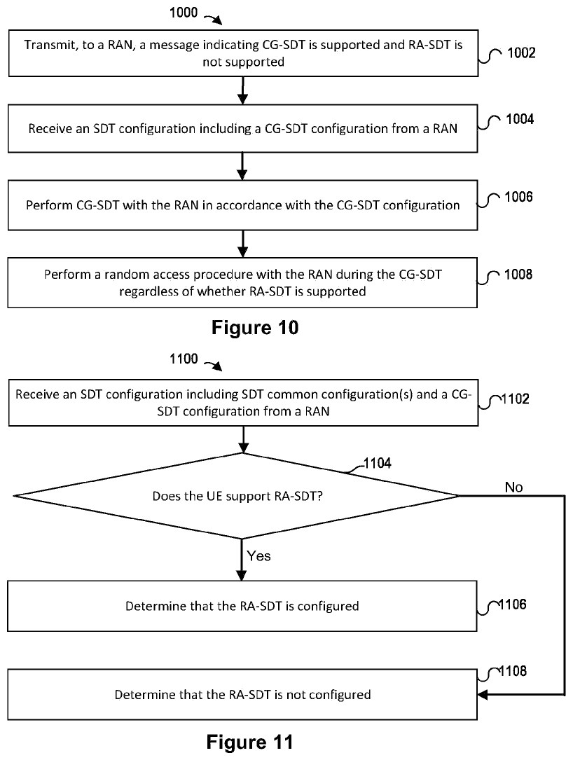

Referring next to FIG. 10, a method 1000 can be implemented in a suitable UE and includes indicating that CG-SDT communication is supported and RA-SDT communication is not before performing CG-SDT in accordance with a configuration received from a RAN.

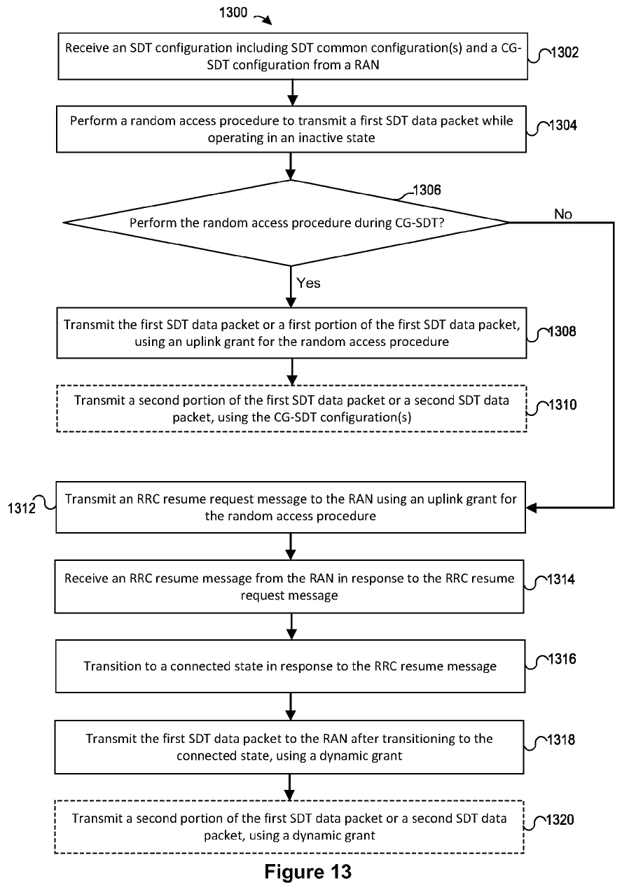

At block 1002, the UE 102 transmits, to a node of a RAN 105, such as base station 104, a message indicating that CG-SDT communication is supported, but RA-SDT communication is not supported (320/394, 420/494, 594, and 694 of FIGS. 3-6). At block 1004, the UE 102 receives an SDT configuration including a CG-SDT configuration from the RAN 105 (334/394, 402/434/494, 502/594, and 602/694 of FIGS. 3-6). At block 1006, the UE 102 performs CG-SDT with the RAN 105 in accordance with the CG-SDT configuration (e.g., events 493/495, 593/595, and 618/694 of FIGS. 4-6). In some implementations, the UE 102 configures time and/or frequency resources in accordance with the CG-SDT configuration before performing CG-SDT with the RAN 105. At block 1008, the UE 102 performs a random access procedure with the RAN 105 during the CG-SDT regardless of RA-SDT communication not being supported. In some implementations, the UE 102 determines that the UE 102 is between transmission periods according to the time or frequency resources configured in accordance with the CG-SDT configuration, and, in response, determines to perform the random access procedure between periods, as described in more detail with regard to FIG. 13 below.

Referring next to FIG. 11, a method 1100 can be implemented in a suitable UE and includes determining whether RA-SDT is configured for a UE 102 based on whether the UE 102 supports RA-SDT communication.

At block 1102, the UE 102 receives an SDT configuration including SDT common configuration(s) and a CG-SDT configuration from a node of a RAN 105, such as base station 104 (334/394, 402/434/494, 502/594, and 602/694 of FIGS. 3-6). At block 1104, the flow diverges based on whether the UE 102 supports RA-SDT communication. In implementations in which the UE 102 does support RA-SDT communication, the flow continues to block 1106. Otherwise, the flow continues to block 1108. At block 1106, the UE 102 determines that the RA-SDT is configured (334/394, 434/494, 594, and 694 of FIGS. 3-6). At block 1108, the UE 102 determines that the RA-SDT is not configured (334/394, 434/494, 594, and 694 of FIGS. 3-6). In implementations in which the UE 102 does not support RA-SDT communication and receives an SDT configuration not including an RA-SDT specific configuration, the UE 102 still determines that the SDT configuration is valid.

In some implementations, the UE 102 transmits, to the RAN 105, a message indicating that CG-SDT communication is supported. For example, the UE 102 can transmit the message (e.g., UECapabilityInformation) including a CG-SDT capability to the RAN 105. In another example, the UE 102 can transmit, to a CN 110 via the RAN 105, the message including a capability ID identifying a number of UE capabilities for the UE 102. The number of UE capabilities can include the CG-SDT capability. In some such implementations, the RAN 105 receives the UE capabilities from the CN 110 and includes CG-SDT configuration(s) in the SDT configuration in response to receiving the CG-SDT capability.

Examples and implementations described in the previous figures can apply to FIG. 11.

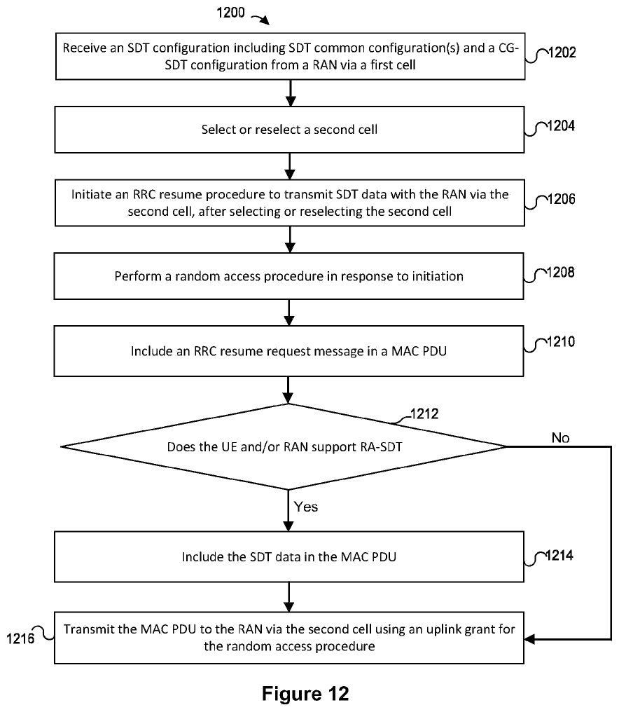

Referring next to FIG. 12, a method 1200 can be implemented in a suitable UE and includes selecting a second cell and transmitting an uplink packet to a RAN, as well as determining whether to include SDT data in the uplink packet based on whether the UE or RAN supports RA-SDT communication.

At block 1202, the UE 102 receives an SDT configuration including SDT common configuration(s) and a CG-SDT configuration from a node of a RAN 105, such as base station 104, via a first cell (334/394, 402/434/494, 502/594, and 602/694 of FIGS. 3-6). At block 1204, the UE 102 selects or reselects a second cell. At block 1206, the UE 102 initiates an RRC resume procedure to transmit SDT data with the RAN 105 via the second cell, after selecting or reselecting the second cell. At block 1208, the UE 102 performs a random access procedure in response to initiating the RRC resume procedure (404/494/495 and 604/694/695 of FIGS. 4 and 6). At block 1210, the UE 102 includes an RRC resume request message in an uplink packet, such as a MAC PDU (e.g., events 404/492/493/495 and 604/692/694 of FIGS. 4 and 6). At block 1212, the UE 102 determines whether the UE 102 and/or the RAN 105 support RA-SDT communication. In implementations in which at least one supports RA-SDT communication, flow continues to block 1214. Otherwise, flow continues directly to block 1216. At block 1214, the UE 102 includes the SDT data in the uplink packet (e.g., events 493/495 and 694 of FIGS. 4 and 6). At block 1216, the UE 102 transmits the uplink packet to the RAN 105 via the second cell using an uplink dynamic grant for the random access procedure (e.g., events 493/495 and 694 of FIGS. 4 and 6).

Examples and implementations described in the previous figures can apply to FIG. 12.

Referring next to FIG. 13, a method 1300 can be implemented in a suitable UE and includes determining whether to transmit an SDT data packet using a configured grant or a dynamic grant based on whether the UE performs a random access procedure during CG-SDT.

At block 1302, the UE 102 receives an SDT configuration including SDT common configuration(s) and a CG-SDT configuration from a node of a RAN 105, such as base station 104 (334/394, 402/434/494, 502/592/594, and 602/694 of FIGS. 3-6). At block 1304, the UE 102 performs a random access procedure to transmit a first SDT data packet, while operating in an inactive state (404/494/495, 542/592, and 604/694/695 of FIGS. 4-6). At block 1306, the flow diverges based on whether the UE 102 performs the random access procedure during CG-SDT. In implementations in which the UE 102 does perform the random access procedure during CG-SDT, flow continues to block 1308. Otherwise, flow continues directly to block 1312. At block 1308, the UE 102 transmits the first SDT data packet or a first portion of the first SDT data packet using an uplink grant for the random access procedure (404/494/495, 542/592, and 604/694/695 of FIGS. 4-6). Depending on the implementation, the uplink grant is included in a 4-step random access procedure or is configured in a random access configuration broadcast in an SIB. In some implementations, at block 1310, the UE 102 transmits a second portion of the first SDT data packet or a second SDT data packet, using the CG-SDT configuration(s) (404/494/495, 542/592, and 604/694/695 of FIGS. 4-6). At block 1312, the UE 102 transmits an RRC resume request message to the RAN 105 using an uplink grant for the random access procedure (404/494/495, 542/592, and 604/694/695 of FIGS. 4-6). Depending on the implementation, the uplink grant is configured similar to the uplink grant in block 1308. At block 1314, the UE 102 receives an RRC resume message from the RAN 105 in response to the RRC resume request message (e.g., event 512 of FIGS. 5A and 5B). At block 1316, the UE 102 transitions to a connected state in response to the RRC resume message (e.g., event 513 of FIGS. 5A and 5B). At block 1318, the UE 102 transmits the first SDT data packet to the RAN 105 using a dynamic grant and after transitioning to a connected state (e.g., event 518 of FIGS. 5A and 5B). In some implementations, at block 1320, the UE 102 transmits a second portion of the first SDT data packet or a second SDT data packet using a dynamic grant to the RAN 105 (e.g., event 518 of FIGS. 5A and 5B). In some implementations, the UE 102 only performs method 1300 when the UE 102 does not support RA-SDT communication. In such implementations, the UE 102 instead performs RA-SDT communication in accordance with methods described herein when the UE 102 does support RA-SDT communication.

Examples and implementations described in the previous figures can apply to FIG. 13.

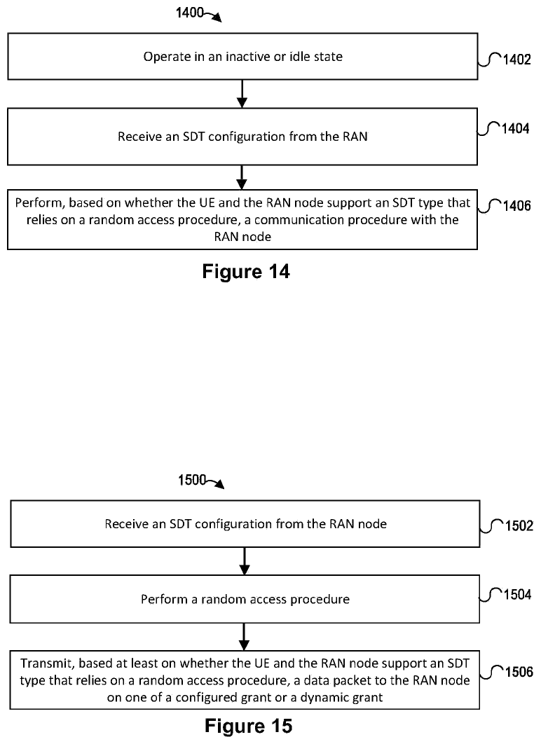

Referring next to FIG. 14, a method 1400 can be implemented in a suitable UE and includes managing small data transmission with a network.

At block 1402, the UE 102 operates in a state of a protocol for controlling radio resources in which the UE is not connected to the RAN (e.g., events 492/493/494, 592/593/595, 692/694, 704, 804, and 904 of FIGS. 4-9). Depending on the implementation, the state is an inactive state or an idle state. At block 1404, the UE 102 receives an SDT configuration from the RAN 105 (e.g., events 334/394, 402/434/494, 502/594, 602/694, 702, 802, 902, 1004, and 1102 of FIGS. 3-11). At block 1406, the UE 102 performs, based on whether the UE and the RAN node support an SDT type that relies on a random access procedure (such as RA-SDT), a communication procedure with the RAN node (e.g., events 493/495, 593/595, 705/706/707/708/710, 806/808/810, 912/914/916, 1006, and 1104/1106/1108 of FIGS. 4-5B and 7A-11).

Examples and implementations described in the previous figures can apply to FIG. 14.

Referring next to FIG. 15, a method 1500 can be implemented in a suitable UE and includes managing small data transmission with a network.

At block 1502, the UE 102 receives an SDT configuration from the RAN node (e.g., events 334/394, 402/434/494, 502/594, 602/694, 1202 and 1302 of FIGS. 3-6, 12, and 13). At block 1504, the UE 102 performs a random access procedure (e.g., events 404/494/495, 604/694/695, 1208 and 1304 of FIGS. 4, 6, 12, and 13). At block 1506, the UE 102 transmits, based at least on whether the UE 102 and the RAN node support an SDT type that relies on a random access procedure (such as RA-SDT), a data packet to the RAN node on one of an uplink configured grant or a dynamic grant (e.g., events 493/495, 694, 1212/1216, and 1306/1308/1318 of FIGS. 4, 6, 12, and 13).

Examples and implementations described in the previous figures can apply to FIG. 15.

The following list of examples reflects a variety of the embodiments explicitly contemplated by the present disclosure:

Example 1. A method for managing small data transmission (SDT) with a radio access network (RAN) including a RAN node, the method implemented in a user equipment (UE) and comprising: operating in a state of a protocol for controlling radio resources in which the UE is not connected to the RAN; receiving an SDT configuration from the RAN; and performing, based on whether the UE and the RAN node support an SDT type that relies on a random access procedure, a communication procedure with the RAN node to transmit or receive small data.

Example 2. The method of example 1, wherein performing the communication procedure includes: in a first instance, performing an SDT procedure in accordance with the SDT type when the UE supports the SDT type; and in a second instance, performing a resume procedure when the UE does not support the SDT type.

Example 3. The method of example 2, further comprising: transmitting, to the RAN node, an indication that the UE supports RA-SDT.

Example 4. The method of example 2 or 3, further comprising: determining that the UE supports the SDT type when a support flag is set to a first value; and determining that the UE does not support the SDT type when the support flag is set to a second value.

Example 5. The method of example 2 or 3, further comprising: determining that the UE supports the SDT type when the UE stores a support flag; and determining that the UE does not support the SDT type when the UE does not store the support flag.

Example 6. The method of example 1, wherein performing the communication procedure includes: in a first instance, performing an SDT procedure in accordance with the SDT type when the RAN node supports the SDT type; and in a second instance, performing a resume procedure when the RAN node does not support the SDT type communication.

Example 7. The method of example 6, further comprising: determining, based on the SDT configuration, that the RAN node supports the SDT type when the SDT configuration includes a configuration specific to the SDT type.

Example 8. The method of example 6 or 7, further comprising: determining, based on the SDT configuration, that the RAN node does not support RA-SDT communication when the SDT configuration does not include a configuration specific to the SDT type.

Example 9. The method of example 7 or 8, wherein the configuration specific to the SDT type includes at least one of: (i) a random access configuration or (ii) a timer value for the SDT type.

Example 10. The method of any of the preceding examples, wherein performing the communication procedure includes: performing an SDT procedure in accordance with the SDT type when the UE and the RAN node support the SDT type; and performing a resume procedure when at least one of the UE or the RAN node does not support the SDT type.

Example 11. The method of any of the preceding examples wherein performing the communication procedure includes: initiating an SDT communication procedure; and determining, after initiating the SDT communication procedure, whether at least one of the UE or the RAN node supports the SDT type.

Example 12. The method of example 11, further comprising: stopping the SDT communication procedure after determining that at least one of the UE or the RAN node does not support the SDT type.

Example 13. The method of example 11 or 12, wherein the initiating is in response to determining that one or more SDT initiation conditions are met.

Example 14. The method of example 13, wherein the one or more SDT initiation conditions include at least one of: (i) whether a system information block of a cell currently used by the UE includes an SDT configuration; (ii) whether all pending data for transmission is associated with radio bearers for SDT; (iii) whether data volume of all pending data is lower than or equal to a first predetermined threshold; or (iv) whether signal strength of a downlink path loss reference is higher than a second predetermined threshold.

Example 15. The method of example 1, further comprising: detecting whether one or more initiation conditions for the SDT type are met; wherein the performing is further based on whether the one or more initiation conditions for the SDT type are met.

Example 16. The method of example 15, wherein performing the communication procedure includes: performing an SDT procedure in accordance with the SDT type when at least one of the UE or the RAN node supports the SDT type and the one or more initiation conditions for the SDT type are met; and performing a resume procedure when the UE and the RAN node do not support the SDT type or the one or more initiation conditions for the SDT type are not met.

Example 17. The method of any of the preceding examples, wherein the SDT type is a first SDT type and the SDT configuration includes a configuration for a second SDT type that relies on a resource previously allocated to the UE, further comprising: detecting whether one or more initiation conditions for the second SDT type are met; and further wherein the performing is further based on whether the one or more initiation conditions for the second SDT type are met.

Example 18. The method of example 24, wherein performing the communication procedure includes: in a first instance, performing an SDT procedure in accordance with the second SDT type when the one or more initiation conditions for the second SDT type are met; and in a second instance, performing one of an SDT procedure in accordance with the first type or a resume procedure when the one or more initiation conditions for the second SDT type are not met.

Example 19. The method of example 17 or 18, wherein the performing is further based on whether at least the UE supports the second SDT type.

Example 20. The method of example 19, further comprising: determining that the UE supports the second SDT type when a support flag is set to a first value; and determining that the UE does not support the SDT type when the support flag is set to a second value.

Example 21. The method of example 19, further comprising: determining that the UE supports the second SDT type when the UE stores a support flag; and determining that the UE does not support the second SDT type when the UE does not store the support flag.

Example 22. The method of any of examples 17-21, wherein receiving the SDT configuration is in response to transmitting a message to the RAN indicating that the UE supports at least one of the first SDT type or the second SDT type.

Example 23. The method of example 22, further comprising: performing a random access procedure during the SDT procedure regardless of whether the UE supports the first SDT type.

Example 24. The method of example 1, wherein the SDT configuration includes an SDT configuration common to multiple types of SDT communication, and further wherein performing the communication procedure includes: determining, based on whether the UE supports the SDT type, whether the UE is configured in accordance with the SDT type; and performing the communication procedure in accordance with the determining.

Example 25. The method of example 24, wherein the SDT type is a first SDT type, the SDT configuration further includes a configuration for the second SDT type, and receiving the SDT configuration is in response to transmitting a message to the RAN node including one or more SDT capabilities for the UE.

Example 26. A method for managing small data transmission (SDT) with a radio access network (RAN) including a RAN node, the method implemented in a user equipment (UE) and comprising: receiving an SDT configuration from the RAN node; performing a random access procedure; and transmitting, based at least on whether the UE and the RAN node support an SDT type that relies on a random access procedure, a data packet to the RAN node on one of an uplink configured grant or a dynamic grant.

Example 27. The method of example 26, wherein receiving the SDT configuration is via a first cell, further comprising: selecting a second cell for communication with the RAN node; and initiating a resume procedure to transmit SDT data associated with the SDT configuration via the second cell; wherein transmitting the data packet includes transmitting the data packet on the uplink configured grant.

Example 28. The method of example 27, wherein the data packet includes the SDT data associated with the SDT configuration when at least one of the UE or the RAN node supports the SDT type.

Example 29. The method of example 28, wherein the data packet includes a resume message.

Example 30. The method of example 26, wherein the SDT type is a first SDT type, the SDT configuration includes a configuration for a second SDT type that relies on a resource previously allocated to the UE, and at least one of the UE or the RAN node does not support the first SDT type, further wherein the transmitting includes: transmitting the data packet based on whether the random access procedure is during communication in accordance with the second SDT type.

Example 31. The method of example 30, the method further comprising:

determining a transmission schedule in accordance with resources associated with the second SDT type; wherein the transmitting the data packet is in response to determining to transmit the data packet without adhering to the transmission schedule.

Example 32. The method of example 30, wherein the transmitting includes: transmitting the data packet on the uplink configured grant when the random access procedure occurs during the communication in accordance with the second SDT type; and transmitting the data packet on the dynamic grant when the random access procedure does not occur during the communication in accordance with the second SDT type.

Example 33. The method of example 32, wherein the data packet is a first portion of a data packet, and further wherein the random access procedure occurs during the communication in accordance with the second type, further comprising: transmitting a second portion of the data packet using the configuration for the second type.

Example 34. The method of example 32, wherein the random access procedure does not occur during the communication in accordance with the second type, further comprising: transmitting a resume message using the dynamic grant; and receiving, in response to transmitting the resume message, an indication to transition to a connected state; wherein transmitting the data packet includes transmitting the data packet on the dynamic grant.

Example 35. The method of example 34, wherein the data packet is a first portion of a data packet, further comprising: transmitting a second portion of the data packet on the dynamic grant.

Example 36. A user equipment comprising processing hardware and configured to implement any of the preceding examples.

The following description may be applied to the description above.

Generally speaking, description for one of the above figures can apply to another of the above figures. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “stop” can be replaced by “suspend”.

In some implementations, the “second UE CG-SDT timer” can be replaced by “CG-SDT retransmission timer (cg-SDT-RetransmissionTimer)”. In some implementations, “CG-SDT”, “CG”, “SDT-CG” can be interchanged.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for managing small data transmission (SDT) with a radio access network (RAN) including a RAN node, the method implemented in a user equipment (UE) and comprising:
operating in an inactive state;
receiving an SDT configuration from the RAN;
detecting whether one or more initiation conditions are met for a second SDT type, wherein the second SDT type is configured grant SDT (CG-SDT);
in a first instance, when the UE supports a first SDT type and the one or more initiation conditions are not met:
performing an SDT procedure in accordance with the first SDT type, wherein the first SDT type is random access SDT (RA-SDT), and
transmitting, to the RAN node, an indication that the UE supports the first SDT type;
in a second instance, when the one or more initiations conditions are met, performing the SDT procedure in accordance with the second SDT type; and
in a third instance, when the UE does not support the first SDT type, refraining from performing the SDT procedure.

2. The method of claim 1, wherein the refraining includes:
in the third instance, performing a resume procedure when the UE does not support the first SDT type.

3. (canceled)

4. The method of claim 1, wherein the first instance further corresponds to when the RAN node supports the first SDT type.

5. The method of claim 4, wherein the refraining includes:
in the third instance, performing a resume procedure when the RAN node does not support the first SDT type.

6. The method of claim 4, further comprising:
determining, based on the SDT configuration, that the RAN node supports the first SDT type when the SDT configuration includes a configuration specific to the first SDT type.

7. The method of claim 4, further comprising:
determining, based on the SDT configuration, that the RAN node does not support the first SDT type communication when the SDT configuration does not include a configuration specific to the first SDT type.

8. The method of claim 6, wherein the configuration specific to the first SDT type includes at least one of: (i) a random access configuration or (ii) a timer value for the first SDT type.

9. The method of claim 1, the method further comprising:
initiating an SDT communication procedure; and
determining, after initiating the SDT communication procedure, whether the UE supports the first SDT type.

10. The method of claim 9, further comprising:
in the second instance, stopping the SDT communication procedure after determining that the UE does not support the first SDT type.

11. The method of claim 9, wherein the initiating is in response to determining that one or more SDT initiation conditions are met.

12. The method of claim 11, wherein the one or more SDT initiation conditions include at least one of:
(i) whether a system information block of a cell currently used by the UE includes an SDT configuration;
(ii) whether all pending data for transmission is associated with radio bearers for SDT;
(iii) whether data volume of all pending data is lower than or equal to a first predetermined threshold; or
(iv) whether signal strength of a downlink path loss reference is higher than a second predetermined threshold.

13. An apparatus, functioning as a user equipment (UE) and configured to manage small data transmission (SDT) with a radio access network (RAN) including a RAN node, the apparatus comprising:
processing hardware configured to:
operate in an inactive state;
receive an SDT configuration from the RAN;
detect whether one or more initiation conditions are met for a second SDT type, wherein the second SDT type is configured grant SDT (CG-SDT);
in a first instance, when the UE supports a first SDT type and the one or more initiation conditions are not met:
perform an SDT procedure in accordance with the first SDT type, wherein the first SDT type is random access SDT (RA-SDT), and
transmit, to the RAN node, an indication that the UE supports the first SDT type;
in a second instance, when the one or more initiations conditions are met, perform the SDT procedure in accordance with the second SDT type; and
in a third instance, when the UE does not support the first SDT type, refrain from performing the SDT procedure.

14. The apparatus of claim 13, wherein the processing hardware configured to refrain from performing the SDT procedure is further configured to:
in the third instance, perform a resume procedure when the UE does not support the first SDT type.

15. The apparatus of claim 13, wherein the first instance further corresponds to when the RAN node supports the first SDT type.

16. The apparatus of claim 15, wherein the processing hardware configured to refrain from performing the SDT procedure is further configured to:
in the third instance, perform a resume procedure when the RAN node does not support the first SDT type.

17. The apparatus of claim 15, wherein the processing hardware is further configured to:
determine, based on the SDT configuration, that the RAN node supports the first SDT type when the SDT configuration includes a configuration specific to the first SDT type.

18. The apparatus of claim 15, wherein the processing hardware is further configured to:
determine, based on the SDT configuration, that the RAN node does not support the first SDT type communication when the SDT configuration does not include a configuration specific to the first SDT type.

19. The apparatus of claim 17, wherein the configuration specific to the first SDT type includes at least one of: (i) a random access configuration or (ii) a timer value for the first SDT type.

20. The apparatus of claim 13, wherein the processing hardware is further configured to:
initiate an SDT communication procedure; and
determine, after initiating the SDT communication procedure, whether the UE supports the first SDT type.

21. The apparatus of claim 13, wherein the one or more initiation conditions include at least one of:
(i) whether a system information block of a cell currently used by the UE includes an SDT configuration;
(ii) whether all pending data for transmission is associated with radio bearers for SDT;
(iii) whether data volume of all pending data is lower than or equal to a first predetermined threshold; or
(iv) whether signal strength of a downlink path loss reference is higher than a second predetermined threshold.
